(19) United States
(12) Patent Application Publication
(10) Pub. No.: US 2024/0301266 A1
(43) Pub. Date: Sep. 12, 2024

(54) POLY(HYDROXY)URETHANES FOR ENCAPSULATING PHASE CHANGE MATERIALS AND METHODS OF MAKING THE S

(71) Applicant: Alliance for Sustainable Energy, LLC, Golden, CO (US)

(72) Inventors: Samuel Davis DAHLHAUSER, Denver, CO (US); Nicholas A. RORRER, Golden, CO (US); Robert David ALLEN, Golden, CO (US); Minjung LEE, Arvada, CO (US)

(21) Appl. No.: 18/585,890

(22) Filed: Feb. 23, 2024

Related U.S. Application Data
(60) Provisional application No. 63/447,748, filed on Feb. 23, 2023.

(51) Int. Cl. C09K 5/06; C08J 9/00; C08J 9/06; C08J 9/40

(52) U.S. Cl. CPC C09K 5/063; C08J 9/0009; C08J 9/06; C08J 9/40; C08J 2375/04

(57) ABSTRACT

The present disclosure relates to a composition that includes a poly(hydroxy)urethane (PHU) foam, a phase change material (PCM), and a solid additive, where the PHU foam includes a plurality of voids, at least a portion of the voids contain the PCM and the solid additive, and the composition is capable of being repeatedly cycled through a temperature range, resulting in the PCM cycling between a solid phase and a liquid phase. In some embodiments of the present disclosure, the PCM may include at least one of a hydrated salt, a paraffin wax, a sugar alcohol, a fatty acid, and/or a eutectic mixture.

### CROSS-REFERENCE TO RELATED APPLICATIONS

This application claims priority from U.S. Provisional Patent Application No. 63/447,748 filed on Feb. 23, 2023, the contents of which are incorporated herein by reference in the entirety.

### CONTRACTUAL ORIGIN

This invention was made with government support under Contract No. DE-AC36-08GO28308 awarded by the Department of Energy. The government has certain rights in the invention.

### BACKGROUND

The critical need to eliminate greenhouse gas (GHG) emissions has resulted in dramatic expansion in renewable energy technologies. A limiting factor for renewable energy technologies exists in the inconsistency between energy supply and demand, resulting from the inherent unpredictability of renewable sources (wind, solar, etc.). Thus, there is an ever-growing need for energy storage technologies to improve energy utilization efficiency.

### SUMMARY

An aspect of the present disclosure is a composition that includes a poly(hydroxy)urethane (PHU) foam, a phase change material (PCM), and a solid additive, where the PHU foam includes a plurality of voids, at least a portion of the voids contain the PCM and the solid additive, and the composition is capable of being repeatedly cycled through a temperature range, resulting in the PCM cycling between a solid phase and a liquid phase. In some embodiments of the present disclosure, the PCM may include at least one of a hydrated salt, a paraffin wax, a sugar alcohol, a fatty acid, and/or a eutectic mixture.

In some embodiments of the present disclosure, the hydrated salt may include at least one of calcium chloride hexahydrate (CaCl₂·6H₂O), Na₂SO₄·10H₂O, Na₂HPO₄·12H₂O, Na₂S₂O₃·5H₂O, CH₃COONa·3H₂O, KF·4H₂O, LiNO₃·3H₂O, and/or (Na₂[B₄O₅(OH)₄]·8H₂O). In some embodiments of the present disclosure, the paraffin wax may include a linear long chain hydrocarbon. In some embodiments of the present disclosure, the PCM may be present at a concentration 0 wt %<x≤85 wt %. In some embodiments of the present disclosure, the PCM may have a heat of fusion 50 J/g≤H≤250 J/g.

In some embodiments of the present disclosure, the solid additive may include at least one of a carbonate salt, a metal oxide, a clay, a zeolite, and/or a carbonaceous material. In some embodiments of the present disclosure, the carbonate salt may include at least one of BaCO₃ and/or Ba₂SO₄. In some embodiments of the present disclosure, the carbonaceous material may include at least one of graphene, graphite, carbon nanotubes, and/or activated charcoal. In some embodiments of the present disclosure, the carbonaceous material may include graphite and the composition may have a thermal conductivity between 0.18 W/mK and 0.195 W/mK. In some embodiments of the present disclosure, the solid additive may be present at a concentration 0 wt %<y≤10 wt %.

In some embodiments of the present disclosure, the PHU foam may be derived from reacting a cyclic carbonate-containing molecule, an amine-containing molecule, and a thiol-containing molecule. In some embodiments of the present disclosure, the cyclic carbonate-containing molecule may include at least one of trimethylpropane tricarbonate (TMPTC), 4,4′-[1,4-cyclohexanediylbis (methyleneoxymethylene)]bis[1,3-dioxolan-2-one], 4,4′-[1,6-hexanediylbis (oxymethylene)]bis [1,3-dioxolan-2-one], 4,4′-[1,2-Ethanediylbis(oxymethylene)]bis [1,3-dioxolan-2-one], and/or ,4′-[1,4-butanediylbis(oxymethylene)] bis[1,3-dioxolan-2-one]. In some embodiments of the present disclosure, the amine-containing molecule may include at least one of spermidine, putrescine (TMD), spermine, cadaverine, and/or m-xylene diamine. In some embodiments of the present disclosure, the thiol-containing molecule may include 2,2′-(ethylenedioxy)diethanethiol (EDT), decanethiol, and/or pentaerythritol tetrakis(3-mercaptopropionate). In some embodiments of the present disclosure, the PHU foam may be derived using a starting ratio of diamine to thiol between 10:1 and 1:1. In some embodiments of the present disclosure, the PHU foam may be derived using a starting ratio of carbonate to amine plus thiol between 0.1:1.0 to 1.10:1.

In some embodiments of the present disclosure, the temperature range may be between −20° C. and 120° C. In some embodiments of the present disclosure, the PCM may melt, as positioned within the voids, at a first temperature, Tₘ, between −20° C. and 120° C. In some embodiments of the present disclosure, the PCM may crystallize, as positioned within the voids, at a second temperature, T_{c}, between −40° C. and 120° C. In some embodiments of the present disclosure, the composition may further include a surfactant. In some embodiments of the present disclosure, the PHU foam is derived from reacting TMPTC, TMD, and EDT, the PCM includes CaCl₂·6H₂O, and the solid additive includes BaCO₃.

An aspect of the present disclosure is a method of making a PHU foam, where the method includes synthesizing the PHU foam by reacting an amine-containing molecule, a thiol-containing molecule, and a carbonate-containing molecule, and infusing a PCM into the PHU foam.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates results from an initial screening of thiol vs. amine concentrations showed an effective foaming window between 0.4 and 0.45 equivalents of thiol, according to some embodiments of the present disclosure.

FIG. 2 illustrates a sample of an exemplary poly(hydroxy)urethane (PHU) foam produced using methods described herein, according to some embodiments of the present disclosure. This is the same foam as illustrated in FIG. 4 for Test #103A.

FIG. 3 illustrates a basic procedure for adding phase change materials (PCMs) to a PHU foam, according to some embodiments of the present disclosure.

FIG. 4 illustrates additional examples of PHU foams synthesized using varying amounts of cyclic-carbonate (trimethylpropane tricarbonate), amine (putrescine), thiol (2,2′-(ethylenedioxy)diethanethiol), and catalysts (DBU and TBAB), according to some embodiments of the present disclosure.

FIG. 5 illustrates PHU foams having different weight percentages of additive and thiol groups, according to some embodiments of the present disclosure.

FIG. 6A illustrates IR spectra showing that adjusting the thiol:amine ratio (molar ratio of functional groups) slightly modified the resultant ratio of carbamate:thioether linkages observed in the final PHU foams, according to some embodiments of the present disclosure.

FIG. 6B illustrates photographs of PHU foams resulting from the different thiol:amine ratios for the samples tested and illustrated in FIG. 6A, according to some embodiments of the present disclosure.

FIG. 7A illustrates (Panel A) differential scanning calorimetry (DSC) plots for two thermal cycles for neat CaCl₂·6H₂O (PCM) and (Panel B) for a foam infused with CaCl₂·6H₂O, but without any additives, according to some embodiments of the present disclosure.

FIG. 7B illustrates DCS plots showing the freezing exotherms and melting endotherms for six cycles for a foam infused with CaCl₂·6H₂O (PCM) and containing 5 wt % BaCO₃ additive, according to some embodiments of the present disclosure.

FIG. 8 illustrates DSC plots for 50 cycles for a foam that was synthesized with 5 wt % BaCO₃ additive using the procedure for PHU foam synthesis described herein, according to some embodiments of the present disclosure.

FIG. 9 illustrates scanning electron micrographs (SEMs) of exemplary PHU foams with BaCO₃ additive (particles shown in the highlighted boxes) distributed within the foams, according to some embodiments of the present disclosure.

FIG. 10 illustrates DSC plots of a PHU foam containing 5% BaCO₃ being successfully cycled through repeated melting and freezing cycles, according to some embodiments of the present disclosure.

FIG. 11 illustrates DSC plots of various PHU foams infused heptadecane (PCM), according to some embodiments of the present disclosure.

FIG. 12 illustrates SEM images of PHU foam compositions containing 1.4 wt % BaCO₃ (additive), according to some embodiments of the present disclosure.

FIG. 13 illustrates foam samples resulting from different amounts of graphite power additive, 3 wt % (top) and 1.5 wt % (bottom), according to some embodiments of the present disclosure.

FIGS. 14A and 14B illustrate SEM images of PHU samples containing 1.5 wt % graphite powder additive, according to some embodiments of the present disclosure.

FIGS. 15A-15H illustrate rheology data obtained from different PHU foam samples, according to some embodiments of the present disclosure.

FIG. 16 illustrates thermal conductivity data obtained from different PHU foam samples, according to some embodiments of the present disclosure.

FIGS. 17A and 17B illustrate temperature and phase change data obtained from different PHU foam samples, according to some embodiments of the present disclosure.

FIGS. 17C-17E illustrate magnified portions of FIGS. 17A and 17B, according to some embodiments of the present disclosure.

### DETAILED DESCRIPTION

The present disclosure relates to polymeric poly(hydroxy)urethanes (PHUs) foams containing phase change materials (PCMs) positioned within the pores and empty spaces of the foam. In some embodiments of the present disclosure, the foam compositions described herein were formulated and synthesized by the reaction of di-, tri-, and/or multi-functional cyclic carbonates with di-, tri-, and/or multi-functional amines and with di-, tri-, and/or multi-functional thiols (see Tables 1-3 below). These reactants are also referred to herein as carbonate-containing molecules, amine-containing molecules, and thiol-containing molecules. The addition of a thiol-containing molecule results in decarboxylation and the subsequent foaming of the material upon the release of carbon dioxide. Reaction 1 summarizes an exemplary reaction for producing an exemplary PHU, where TMPTC=trimethylpropane tricarbonate; EDT=2,2-(ethylenedioxy)diethanethiol; and TMD=putrescine. Typical catalysts used in the synthesis of foams reported herein were tetrabutylammonium bromide (TBAB) and 1,8-diazabicyclo[5.4.0]undec-7-ene (DBU).

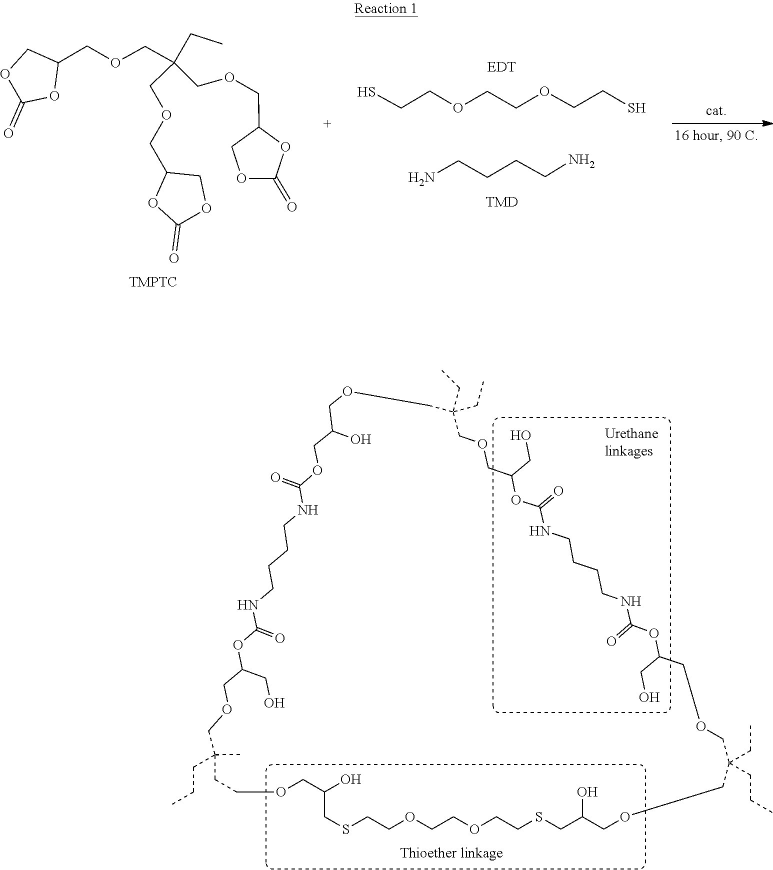

Thiol chemistry can provide the self-foaming aspect of the PHUs. Thiol promoted foaming of PHU foams can be tuned by taking advantage of the competitive chemo- and regio-selective reaction of thiols and amines to the cyclic carbonate (Reaction 2).

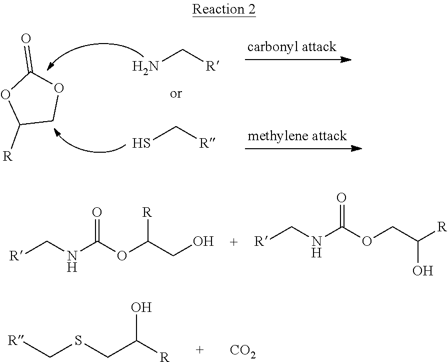

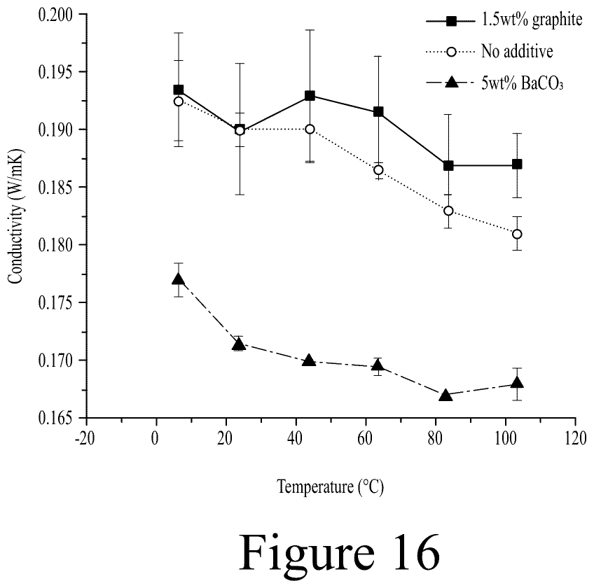

Thus, the present disclosure relates to compositions of self-foaming, bio-derivable, PHUs that are combined with PCMs and/or additives positioned withing the pores of the PHU foams. These PHU foams are capable of containing numerous additives, which among other things, may act as nucleating agents (nanoparticles, porous minerals, expanded graphite, dispersed salts), while introducing minimal changes, if any, to the physical properties of the PHU foams. Further, the inclusion of additives in foamed PHU compositions such as expanded graphite can modulate the thermal conductivity of the compositions (see FIG. 16, which is described in more detail below), thereby providing an extra level of control to an important physical property for insulating materials. In some embodiments of the present disclosure, various additives, for example salt hydrates such as BaCO₃, were positioned within the PHUs. As shown herein, the resulting unique combinations of materials can result in PHU foams containing stable PCMs dispersed therein, capable of being repeatedly cycled between solid and liquid states, resulting in longer functional lifespans for the compositions. Additives may be incorporated into a PHU foam by mixing them into the starting reacting mixture of amine-, thiol-, and carbonate-containing molecules.

As a result, PCMs can effectively store and release thermal energy as a response to their surrounding environmental temperature in the form of a phase change, by melting (absorbing heat) and freezing (releasing heat). By imbedding/encapsulating PCMs in the pores of PHU foams, and, in some embodiments of the present disclosure, by also positioning additives in the PHU foams, the melt and freeze cycles of the PCMs can be stabilized, allowing this freeze/melt process to be precisely repeated over many cycles. This stabilization addresses a known issue in the field of PCMs, which is the cycling instability of many PCMs. By stabilizing melt/freeze cycling, PCMs may be effectively implemented as a material for thermal regulation of buildings and vehicles, among other thermoregulated sectors (e.g., clothing, electronics, etc.). Efficient thermal regulation of these energy intensive applications has significant implications for energy efficiency and decarbonization of the economy.

As a foam, a PHU foam may include a plurality of voids, where at least a portion of the voids may contain at least one of a PCM and/or a solid additive. In some embodiments of the present invention, at least a portion of the voids may be completely filled and/or partially filled with a gas, such as CO₂ and/or air. Therefore, a composition may have different phases present, e.g., solid, liquid, and/or gas. As a result of the presence of different phases, one or more surfaces and/or interfaces may be present in the composition, e.g., gas/solid interfaces, gas/liquid interfaces, and/or solid/liquid interfaces. In some embodiments of the present disclosure, a PCM and/or solid additive may be positioned at at least a portion of at least one of these interfaces and/or on at least a portion of the surfaces. In some embodiments of the present disclosure, a PCM and/or solid additive may be positioned at at least a portion of a gas/solid interface formed by a gas-containing void and the solid phase of a PHU. In such an example, a PCM and/or solid additive may be positioned on a surface or portion of a surface of a solid phase.

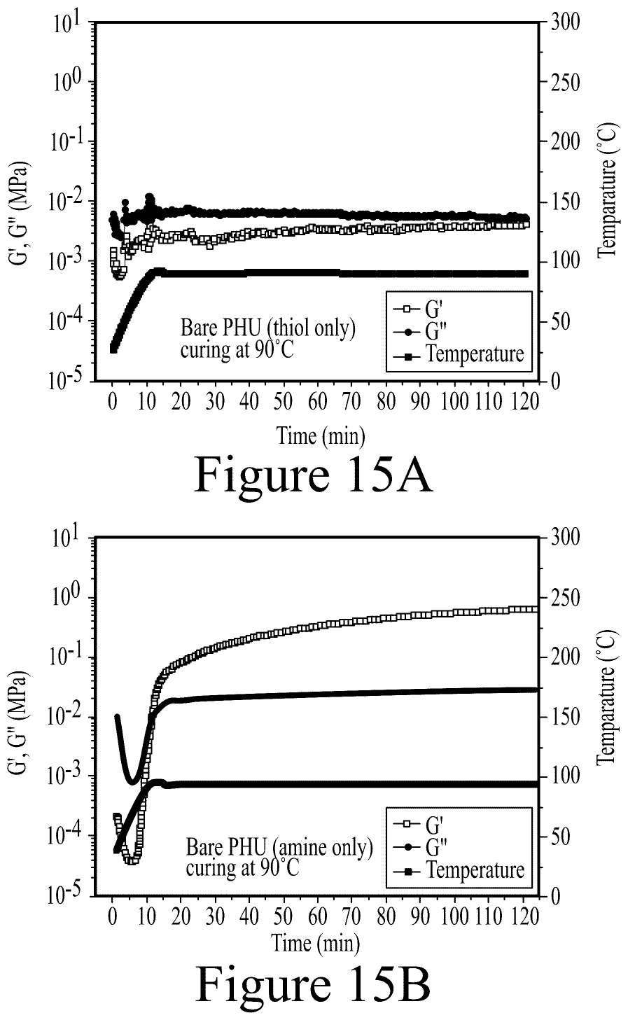

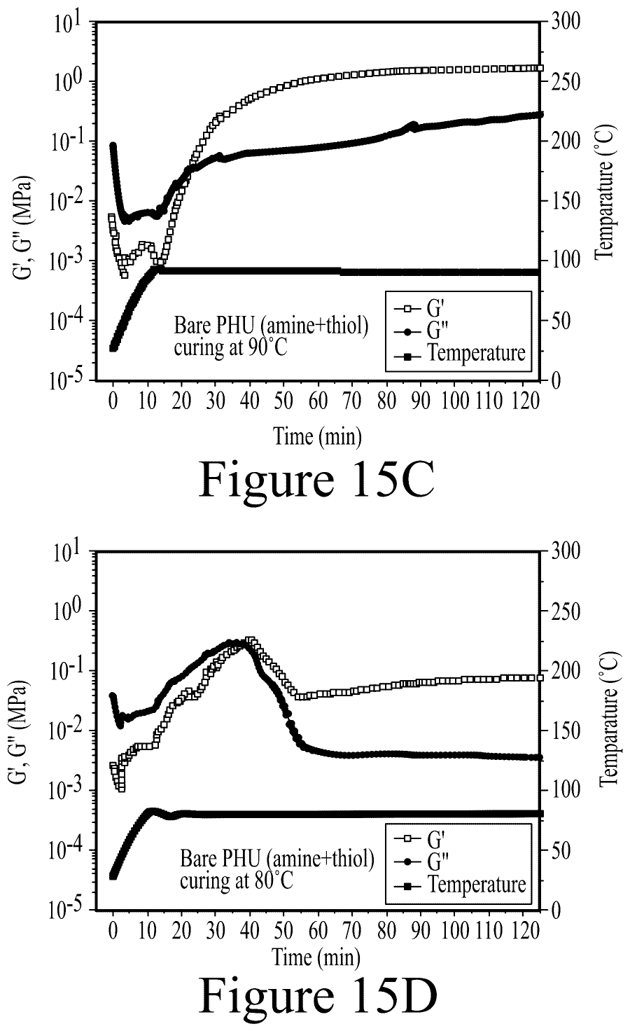

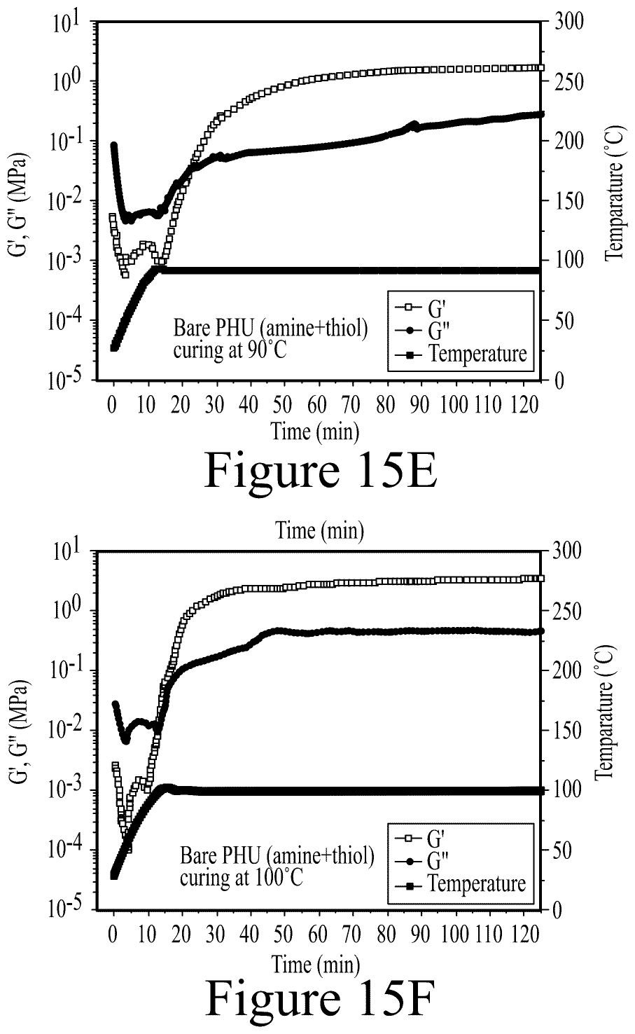

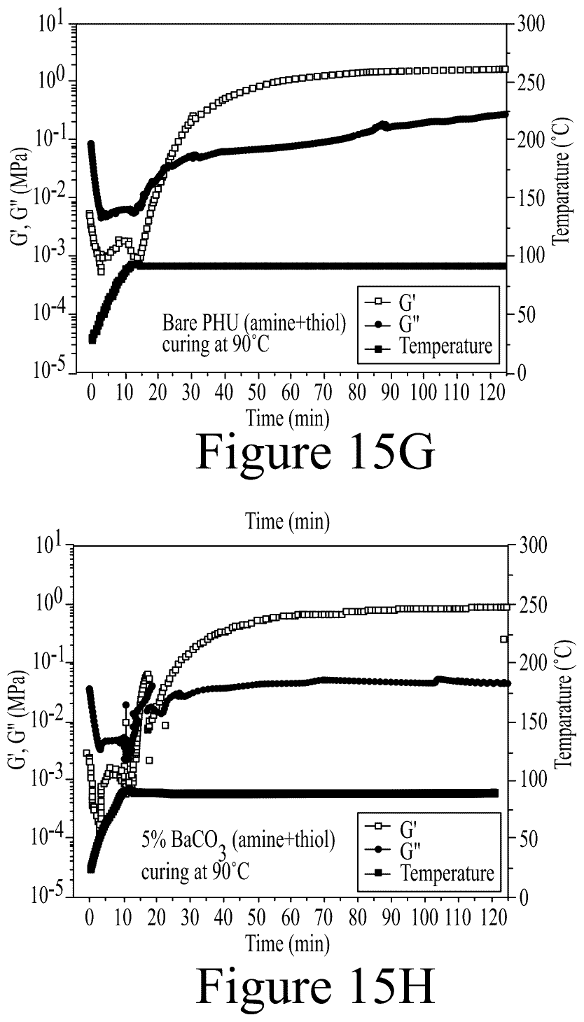

A composition as described herein may be characterized by the voids contained in the foam, for example, the shape, size, number, concentration within the solid phase of a PHU, and/or volume concentration of the voids within the solid phase of the PHU. In some embodiments of the present disclosure, the voids contained within a PHU may have a substantially spherical shape, an elliptical shape, an oblong shape, and/or a polyhedral shape, among others. Voids may also be characterized by a characteristic length (e.g., for oblong voids), a characteristic diameter (e.g., for spherical voids), and/or any other metric or metrics typically used to characterize a shape. In some embodiments of the present disclosure, the voids contained within the solid PHU phase may be substantially spherical shape having an average diameter between 0.1 m and 3 mm, or between m and 500 m. In some embodiments of the present disclosure, the plurality of voids, with or without PCM and solid additive, may be at a volume concentration (relative to the PHU plus the voids) between 10 vol % and 90 vol %, or between 50 vol % and 80 vol % of the composition. As described in more detail below, void shapes, sizes, and concentrations may be controlled during the synthesis of the composition by a number of variables, including additive type, additive size, distribution, and amount, as well as the rate of blowing, where the term “rate of blowing” refers to the release of CO₂ resulting from the thiol attack on the cyclic carbonate ring as shown above in Reaction 2. The rate of CO₂ evolution can be controlled by the amine/thiol ratio and/or the curing temperature and also depends on viscosity. CO₂ evolution begins during curing only if the precured foam reaches a viscosity (the value of this viscosity varies in different formulations) corresponding to the point where the storage modulus (G′) intersects the loss modulus (G″), i.e., the gel point, is reached (see FIGS. 15A-15H, which are explained in more detail below).

The amounts of both PCM and additives contained within a PHU-containing composition are additional independent variables that can be controlled. Additive related variables include the amount, or weight percent, of an additive added prior to curing and foaming. The amount of PCM incorporated into a composition is determined by the overall porosity of the PHU foam, and/or the physical amount of PCM added during vacuum infusion, where “vacuum infusion” refers to the infiltration of PCM in the molten state into the foam during the application of vacuum to the foam. For example, the concentration of PCM present, relative to the entire solid composition (PHU, PCM, and additives), may be between greater than 0 wt % and 90 wt % (0 wt %<x≤90 wt %), or between 40 wt % and 75 wt % (40 wt %<x≤75 wt %) and the concentration of one or more solid additives (relative to the entire solid composition) may be between greater than 0 wt % and 10 wt %, or between 0.1 wt % and 5 wt %. The wt % of additive may be determined by the minimum amount of additive required to achieve cycling stability of the PCM while maintaining the mechanical integrity of the PHU foam, which among other things, may include maintaining sufficient modulus, compliance, and/or ductility, depending on the desired application. The PCM loading may be maximized so as to have the largest energy density per gram of material for cost effective application. Energy densities of some PCMs that may be utilized in compositions described herein range from between 130 J/g to 150 J/g for hydrocarbons such as hexadecane, heptadecane, and octadecane, and between 120 J/g and 140 J/g for salt hydrates such as CaCl₂-6H₂O. PCM loading is generally determined by compatibility (hydrophobic and hydrophilic interactions of the PHU and PCM), as well as by the overall porosity (the less dense the foam, the higher the loading).

A number of different PCMs may be utilized in the PHU foams described herein, and include at least one of a hydrated salt, a paraffin wax, a sugar alcohol, a fatty acid (palmitic acid, stearic acid), or a eutectic mixture (Na₂HPO₄·12H₂O-Na₂CO₃·10H₂O, Na₂HPO₄·12H₂O—K₂HPO₄·3H₂O, Na₂SO₄·10H₂O-Na₂CO₃·10H₂O) Examples of hydrated salt include calcium chloride hexahydrate (CaCl₂·6H₂O), Na₂SO₄·10H₂O, Na₂HPO₄·12H₂O, Na₂S₂O₃·5H₂O, CH₃COONa·3H₂O, KF·4H₂O, LiNO₃·3H₂O, Na₂CO₃·10H₂O and/or (Na₂[B₄O₅(OH)₄]·8H₂O). Examples of paraffin waxes include linear long chain hydrocarbons, such as tetradecane, pentadecane, hexadecane, heptadecane, octadecane, nonadecane, and/or icosane. Examples of sugar alcohols, include multi-hydroxylated compounds such as xylitol, sorbitol, erythritol, maltitol, isomalt, and/or lactitol. Further, a PCM used in the compositions described herein may be characterized by its heat of fusion (i.e., H, enthalpy). In some embodiments of the present disclosure, the heat of fusion of a PCM may be between 50 J/g and 300 J/g or between 80 J/g and 150 J/g.

As stated above, the compositions described herein may be repeatedly cycled through a temperature range, where the PCM is cycled between a solid phase and a liquid phase. In some embodiments of the present disclosure, a PCM positioned within the voids of a PHU foam may melt at a first temperature between −20° C. and 120° C. or between −10° C. and 60° C., where the first temperature is referred to as a melt temperature, Tₘ. In some embodiments of the present disclosure, a PCM positioned within the voids of the composition, may solidify (i.e., freeze) at a second temperature between −20° C. to 120° C. or between −10° C. to 60° C., where the second temperature is referred to as a crystallization temperature, T_{c}. Ideally, the melt temperature and crystallization temperature are approximately the same or in the same vicinity. In some embodiments of the present disclosure, the difference between Tₘ and T_{c} (Tₘ−T_{c}) may be in a range between 5° C. and 40° C., or between 30° C. and 40° C., or between 5° C. and 10° C. Differences in melting and freezing temperatures occur due to the kinetics of nucleation, where there is an inherent competition between the surface energies that repel the creation of new interfaces, along with a driving force to create a more stable phase.

As shown herein, a number of different solid additives may be used to assist with stabilizing a PCM within a PHU/PCM/additive/foam composition. These include at least one of a carbonate salt, a metal oxide, a clay, and/or a mineral elemental carbon (graphite, activated charcoal). Examples of carbonate salts include barium carbonate (BaCO₃) and Ba₂SO₄. Examples of metal oxides include TiO₂, MgO, Al₂O₃ and BaO₂. Examples of clays (i.e., minerals) include silica, celite, montmorillonite, and/or a zeolite. Solid additives may also be used to adjust the thermal conductivity of the polymer foam composite. Carbonaceous additives include graphene, carbon black, and/or carbon nanotubes. Solid additives may be introduced into a PHU foam by mixing them into the starting reacting mixture, or at least one of the reactants; e.g., mixed with at least one of an amine-containing molecule, carbonate-containing molecule, and/or thiol-containing molecule.

In general, the PHU foams described herein were synthesized by reacting one or more a cyclic carbonate-containing molecules with at least one amine-containing molecule and at least one thiol-containing molecule. In some embodiments of the present disclosure, a PHU foam may be synthesized by reacting a multifunctional cyclic carbonate with at least one of a diamine and/or polyamine and at least one of a thiol and/or a dithiol. In some embodiments of the present disclosure, a cyclic carbonate may include at least two cyclic carbonate groups, or at least three cyclic carbonate groups. Exemplary cyclic carbonates are summarized below in Table 1, exemplary diamines in Table 2, and exemplary thiols in Table 3.

TABLE 1
Cyclic Carbonates

| # | Name | Structure |
|---|---|---|
| C1 | trimethylpropane tricarbonate (TMPTC) | 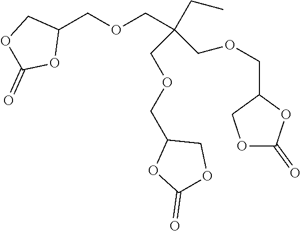 [SMILES: CCC(COCC1COC(=O)O1)(COCC1COC(=O)O1)COCC1COC(=O)O1] |
| C2 | 4,4′-[1,4-cyclohexanediylbis (methyleneoxymethylene)]bis[1,3- dioxolan-2-one] | 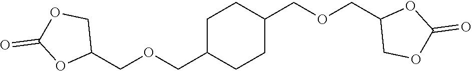 [SMILES: O=C1OCC(COCC2CCC(COCC3COC(=O)O3)CC2)O1] |
| C3 | 4,4′-[1,6-hexanediylbis (oxymethylene)]bis[1,3-dioxolan- 2-one] | 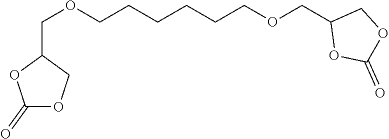 [SMILES: O=C1OCC(COCCCCCCOCC2COC(=O)O2)O1] |
| C4 | 4,4′-[1,2- Ethanediylbis(oxymethylene)]bis [1,3-dioxolan-2-one] | 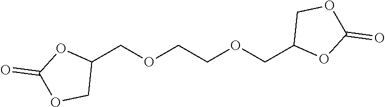 [SMILES: O=C1OCC(COCCOCC2COC(=O)O2)O1] |
| C5 | 4,4′-[1,4- butanediylbis(oxymethylene)] bis[1,3-dioxolan-2-one] | 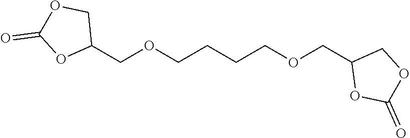 [SMILES: O=C1OCC(COCCCCOCC2COC(=O)O2)O1] |

TABLE 2
Diamines

| # | Name | Structure |
|---|---|---|
| D1 | spermidine | 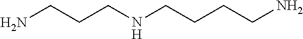 |
| D2 | putrescine (TMD) | 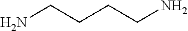 |
| D3 | spermine | 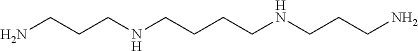 [SMILES: NCCCNCCCCNCCCN] |
| D4 | cadaverine | 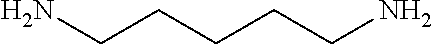 |
| D5 | m-xylene diamine | 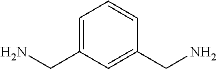 |
| D6 | tris(2-aminoethyl) amine | 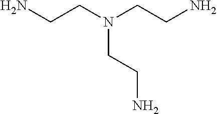 |

TABLE 3
Thiols and Dithiols

| # | Name | Structure |
|---|---|---|
| T1 | 2,2′-(ethylenedioxy)diethanethiol (EDT) | 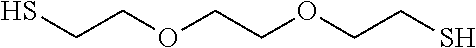 |
| T2 | decanethiol | 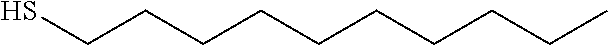 |
| T3 | pentaerythritol tetrakis(3- mercaptopropionate) | 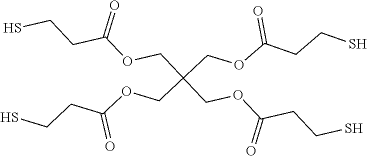 [SMILES: O=C(CCS)OCC(COC(=O)CCS)(COC(=O)CCS)COC(=O)CCS] |

In some embodiments of the present disclosure, a thiol, e.g., a dithiol, may include between 2 and 100 (2≤n≤100) PEG (polyethyleneglycol) spacers positioned between adjacent thiol groups, where a PEG spacer has the structure,

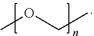

In some embodiments of the present disclosure, a PHU may be derived using a starting ratio of diamine groups to thiol groups between 10:1 and 1:1 or between 2.25:1 and 3.5:1. In some embodiments of the present disclosure, the number of cyclic carbonate groups provided in a formulation will be approximately equal to the total of the number of thiol groups plus amine groups.

In some embodiments of the present disclosure, additional materials may be included in a formulation used to synthesize a PHU foam as described herein. Examples include glycerol, an alcohol (e.g., ethanol), and/or a surfactant (e.g., a silicone surfactant such as polydimethyl siloxane (PDMS) or a material containing polyethylene oxide-co-polypropylene oxide pendent groups).

Among other things, the timing for completing the various steps needed to produce a final PHU foam is important. A workable viscosity (<1000 cP) resulting from the reaction of cyclic carbonate with the diamine (referred to herein as “gelling” reaction) should be achieved prior to generating foam by reacting the carbonate groups with thiol groups (referred to herein as the “blowing” reaction). Such a “workable” viscosity is achieved when the gel point is reached, as described previously. In general, changing a reactant results in the viscosity of the mixture changing accordingly during the gelling reaction, and the rate of gelling also changes accordingly. Likewise, additives can create nucleation sites for air bubbles, which can affect overall foam morphology.

The following describes an exemplary method for synthesizing a PHU foam composition, according to some embodiments of the present disclosure. Typically, the cyclic carbonate and TBAB, an exemplary catalyst, was added to a mold (e.g., a cylindrical inert plastic container). The sample was mixed until the TBAB was dissolved. Next, the thiol was added and the mixture stirred until homogenous. Next, a second catalyst (DBU) and surfactant were added and the mixture was stirred until homogenous, thereby initiating the generation of CO₂ and foam. Finally, the diamine was added, starting the “gelling” reaction and the resultant mixture was mixed for about 10 minutes. Upon addition of the amine, at room temperature, aminolysis of the carbonate began and the gelation progressed as a function of time. After about 10 minutes of stirring, the reaction mixture was stirred by asymmetric centrifugal mixing (Flacktek Speedmixer) for about 10 minutes at ˜3000 rpms. The reaction was left to sit in a closed container at room temperature for 40 minutes and was then placed in an oven at 90° C. for 16 hours to complete the cure. Typically, almost complete cure (˜99%) was achieved in about 2 hours; 16 hours was completed to insure complete curing was achieved. For the PHU foams containing additives, the additives were added during at least one of the TBAB dissolving step, after the TBAB dissolving step, during the thiol addition, after the thiol had homogenized in the mixture, during the addition of DBU catalyst and surfactant, after the DBU and surfactant had homogenized in the mixture, during the addition of the amine, and/or after the addition of the amine.

In some embodiments of the present disclosure, at least a portion of the voids was filled with the PCM by placing the foam in a melted solution of PCM and/or additive at a temperature between 0° C. and 120° C. and applying a vacuum between 10⁻² mbar and 1 bar, and cycling the pressure between these minimum and maximum values between 1 to 10 times until the voids were filled or at least partially by the PCM. This was typically performed by providing excess amounts of PCM, e.g., more than enough to fill 100% of the void volume provided by the foam. This procedure would typically result in the PCM being present in the final PHU foam at a concentration between greater than 0 wt % and less than or equal to 85 wt % or between 40 wt % and 75 wt %.

Various catalysts may be used to enhance the rate of aminolysis and S-alkylation (the reaction of the thiol with the methylene) to varying extents, such as 1,8-diazabicyclo[5.4.0]undec-7-ene (DBU), 1,5-diazabicyclo[4.3.0]non-5-ene (DBN), 4-dimethylaminopyridine (DMAP), and/or 1,4-diazabicyclo [2.2.2.]octane (DABCO). Important to the foaming chemistry, aminolysis is always faster than S-alkylation, allowing one to tune the viscosity of the reaction mixture prior to CO₂ release and foam expansion, providing some control over pore size, pore density, and open- and closed-cell morphologies. In some embodiments of the present disclosure, DBU was selected as the catalyst to achieve a workable viscosity prior to curing and promote both aminolysis and thiol alkylation at lower curing temperatures. For example, viscosity ranges corresponding to the gel points for the materials described herein ranged between about 7,000 Pa·s and about 30,000 Pa·s at a temperature range between about 23° C. and about 25° C. (e.g., approximately room temperature).

The terpolymerization of difunctional amines and difunctional thiols with a trifunctional carbonate in the presence of DBU to produce a highly crosslinked PHU foam was explored. The monomers selected for this step-growth polymerization are shown in Reaction 1, above. Tetramethylene diamine (TMD), also known as putrescine, was chosen as a biogenic and nonhazardous diamine that can be produced from a renewable feedstock. Trimethylpropane tricarbonate (TMPTC) was investigated due to its ability to sequester a significant amount of carbon dioxide per gram of starting material (˜300 g CO₂ per kilogram of trimethylolpropane triglicydyl ether) and sourcing as a cheap commodity chemical. The use of thiols for an in situ blowing agent can create an unpleasant odor, thus 2,2-(ethylenedioxy)diethanethiol (EDT) was selected for its low volatility.

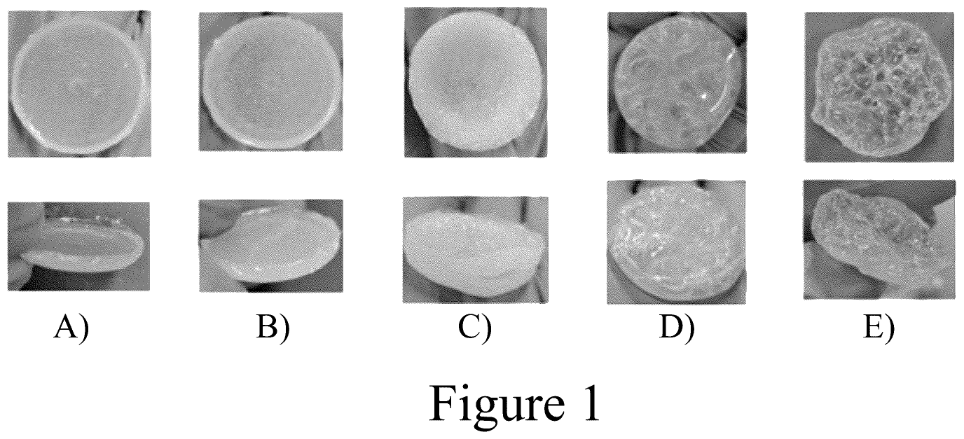

Foam formulations were prepared by mixing near stoichiometric amounts of complementary reactive groups for the step-growth polymerization of TMPTC (carbonate), EDT (thiol), and TMD (amine) (if [TMPTC]/[TMD]/[EDT]=1/1.025/0.45 then [Carbonate]/([Amine]+[Thiol])=−1 with a 0.05 eq excess of carbonate functionality), with 10 mol % DBU and 0.5 wt % silicone surfactant (Vorasurf 5986 from Dow Chemical), relative to the amount of PHU or carbonate plus amine plus thiol. The calculation is based on the following: TMPTC has three carbonate groups, TMD has two amine groups, and EDT has two thiol groups. Therefore, in some embodiments of the present disclosure, the ratio of carbonate to (amine+thiol) may be equal to about 1*3:(1.025+0.45)*2=3:2.95 (i.e., 1:0.983), with a 0.05 equivalent excess of carbonate remaining. An initial screen of thiol versus amine concentrations showed an effective foaming window between 0.4 and 0.45 equivalents of thiol (as provided by the EDT), relative to carbonate (as provided by the TMPTC). Insufficient thiol resulted in insufficient decarboxylation and blowing of the thermoset, and too much thiol resulted in polymers with large, heterogeneously distributed pockets of gas (see FIG. 1). As the percentage of thiol increased, the rate at which the viscosity increased from room temperature aminolysis was slowed, allowing for cell drainage and coalescence of the air bubbles during cure. As such, higher concentrations of thiol may result in less dense foams given that a preferred viscosity may be achieved prior to decarboxylation. The equivalents of each experiment illustrated in FIG. 1 are tabulated below in Table 4. As used herein, the term “equivalent” refers to moles of reactive group, e.g., amine, thiol, or carbonate, provided by an amine-containing molecule, thiol-containing molecule, and carbonate-containing molecule (not moles of the actual molecules themselves).

TABLE 4
Reactant Amounts Corresponding to FIG. 1

| | Carbonate | Amine | Thiol | Amine:Thiol | Carbonate:(Amine + |
|---|---|---|---|---|---|
| Run | (eq) | (eq) | (eq) | ratio | Thiol) ratio |
| A | 1.0 | 1.3 | 0.2 | 6.5:1 | 0.67:1 |
| B | 1.0 | 1.2 | 0.3 | 4.0:1 | 0.67:1 |
| C | 1.0 | 1.1 | 0.4 | 2.75:1 | 0.67:1 |
| D | 1.0 | 1.0 | 0.5 | 2.0:1 | 0.67:1 |
| E | 1.0 | 0.9 | 0.6 | 0.6:1 | 0.67:1 |

While screening for suitably performing formulations, precure, and curing conditions, it was observed that residual tetrabutylammonium bromide (TBAB) content from the carbonation reaction provided varying foam morphologies even when controlling for stoichiometry, cure time, and cure temperature. As a control, two samples were prepared from a purified stock of TMPTC, one with a catalytic amount of TBAB and one without. The sample without TBAB did not foam, but instead formed a rubbery thermoset with large, vacuous pockets of irregular size, shape, and distribution (see FIG. 1).

Thus, it was presumed that the final content of urethane and thioether linkages remained constant, but the rate at which the linkages were formed, along with the viscosity as a function of time, varied. Thermogravimetric (TGA) analysis showed a significantly lower threshold for the onset of decarboxylation between two samples of TMPTC (0.1 equivalents of TBAB vs. neat).

An initial screen of thiol vs. amine concentrations showed an effective foaming window between 0.4 and 0.45 equivalents of dithiol, based on the relative porosity and density observed under an optical microscope. Too little thiol (<0.4 eq) shows a closed cell structure with sparsely distributed air bubbles, while too much thiol (>0.45) shows large coalesced vacuous pockets. (See FIG. 1.) Table 5 summarizes additional experiments using varying amounts of carbonate (TMPTC), amine tris(2-aminoethyl)amine, and thiol (2,2′-(ethylenedioxy)diethanethiol), according to some embodiments of the present disclosure

TABLE 5
Experimental Conditions and TGA Results

| Run | Carbonate | Amine | Thiol | Amine:Thiol | Carb:(amine + | TBAB | T₀ | Tₘₐₓ |
|---|---|---|---|---|---|---|---|---|
| # | (eq) | (eq) | (eq) | ratio | thiol) raito | (eq) | (° C.) | (° C.) |
| 0 | 1.0 | 0 | 0 | NA | NA | 0 | 216.4 | |
| 1 | 1.0 | 0 | 0 | NA | NA | 0.1 | 199.9 | |
| 2 | 1.0 | 0 | 0 | NA | NA | 0.2 | 199.27 | |
| 3 | 1.0 | 0 | 0 | NA | NA | 0.3 | 195.11 | |
| 4 | 1.0 | 0.5 | 0 | NA | 2:1 | 0.1 | 222.93 | |
| 5 | 1.0 | 0.5 | 0 | NA | 2:1 | 0.2 | 218.91 | |
| 6 | 1.0 | 0.5 | 0 | NA | 2:1 | 0.3 | 212.75 | |
| 7 | 1.0 | 0 | 0.5 | 0 | 2:1 | 0.1 | 130.27 | 198.75 |
| 8 | 1.0 | 0 | 0.5 | 0 | 2:1 | 0.2 | 122.47 | 197.51 |
| 9 | 1.0 | 0 | 0.5 | 0 | 2:1 | 0.3 | 119.47 | 195.51 |

T₀ is the temperature at which weight loss begins; Tₘₐₓ is the temperature of maximum degradation

### Experimental Methods and Results

Synthesis of Cyclic Carbonates: To a 600 mL T316 stainless steel reaction cylinder was added 250 mL of trimethylol propane triglycidyl ether (289.25 g, 0.9566 mol) followed by tetrabutylammonium bromide (28.9 g, 10 wt %). The loaded reaction vessel was properly fastened to the Parr reactor (equipped with magnetically coupled stirring rod) according to the manufacturers protocol. While stirring, the reactor was pressurized with CO₂ (industrial grade, Airgas) and degassed 3 times to remove residual air. The vessel was pressurized to 500 psi with CO₂ and brought to 140° C. Reactor was supplied with CO₂ throughout the course of the reaction as the gas is dissolved and consumed. Reaction was left to stir overnight. The cooled reaction mixture was transferred to a 1 L separatory funnel with EtOAc. Organic layer was extracted 3× with water, lx with brine, and concentrated. To remove residual TBAB, the organic was redissolved in dichloromethane and extracted 3× with water, lx with brine, and dried over Na₂SO₄ and concentrated and isolated as a pale-yellow viscous oil. ¹H and ¹³C NMR matched what was reported in the literature.

Reactions were set up according to the procedure above. To the vessel was added 1,4-butanediol diglycidyl ether (Erisys GE-21 from Azelis Americas) (300 g, x mol) followed by tetrabutylammonium bromide (30 g, 10 wt %). Product was isolated as a crude orange-colored oil.

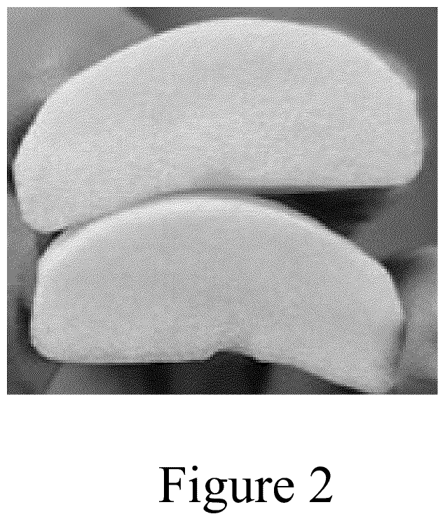

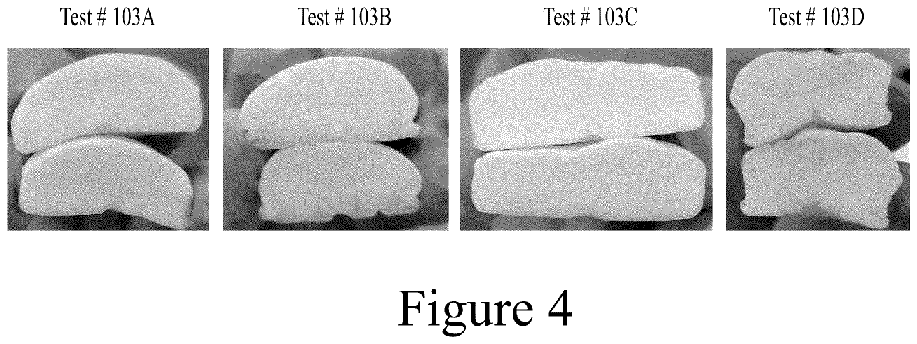

Foam Thermosetting, General Preparation: To tripropyl carbonate (1 equiv) was added tetrabutylammonium bromide (0.1 eq, 6.9 wt %). The mixture was stirred until the TBAB is dissolved. Next, 2,2′-(ethylenedioxy)diethanethiol was added (0.45 equiv) and the viscous mixture was stirred. Next, 1,8-(Diazabicyclo(5.4.0)undec-7ene (0.1 equiv) and Vorasurf 5986 (Dow Chemical) (0.5 wt % of the final thermoset weight). The mixture was stirred again until homogenous. Finally, the 1,4-diaminobutane was added (1.025 equiv). The mixture was immediately stirred by hand for 10 minutes. Immediate aminolysis was observed as the mixture warmed and became more viscous. Next, the mixture was stirred by asymmetric centrifugal mixing (Flacktek Speedmixer) for 10 minutes at 3000 rpms. The reaction was left to sit in a closed container for 40 minutes and was then placed in an oven at 90° C. for 16 hours. The PHU foam was then characterized by IR, TGA, and DSC. FIG. 2 illustrates a sample of the resultant foam PHU produced. This is the same foam as illustrated in FIG. 4, sample 103A.

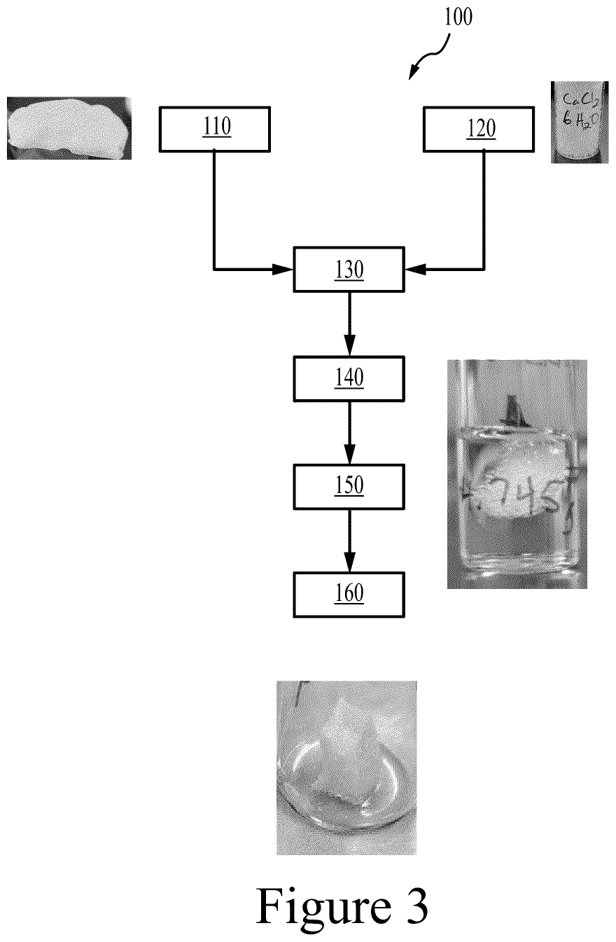

PHU foams were infused with PCMs. This involved synthesizing the foam as described above of which a portion of the foam was cut out. The portion of foam was then physically immersed in melted PCM. Next, vacuum was repeatedly applied and released, resulting in at least a portion of the PCM being transferred into the pores of the PHU foam. The PCM-containing foam was then removed from the remaining melted PCM and cooled, resulting in the PCM-containing PHU foam composition. This method can be generalized as illustrated in FIG. 3. Method 100 may begin synthesizing 110 a PHU foam and melting 120 at least one PCM. The PHU foam and PCM may then be contacted with each other in a combining 130 step. In some embodiments of the present disclosure, the combining 130 may be performed by immersing the PHU foam in the melted PCM. Once the PHU foam is immersed, the method may proceed with applying vacuum 140 to the environment containing the PHU foam and the melted PCM. For example, the combining 130 may be performed in a closed vessel to which a vacuum can be applied to the head-space above the PHU foam and melted PCM mixture. Applying vacuum 140 may result in the transfer of the melted PCM into the void spaces of the foam PHU. Once this transfer is considered complete, the method 100 may continue with the separating 150 of the now PCM-infused foam from the remaining melted PCM. Once removed, the PCM-infused foam may proceed to a cooling 160 step, to recrystallize the PCM within the PHU foam. In some embodiments of the present disclosure, a method for infusing a PHU foam may exclude the application of vacuum. Instead, in some embodiments of the present disclosure, a combining 130 may include the direct injection of a PCM in the melted state into the PHU foam. Thus, the PHU foam may not be immersed in the liquid PCM, simplifying the process. Direct injection may be achieved using a syringe.

Table 6 summarizes some of the experiments completed testing various PCMs and additives for synthesizing PCM-containing PHU foam compositions, according to some embodiments of the present disclosure. Regarding the experiments summarized in Row #1, repeated heptadecane cycling was successfully completed. Regarding the “Foam 103A” test in Row #3, cycling was not reproducible. Regarding the “Foam 103A” test in Row #7, vacuum infusion of the PCM was not successful. Regarding the “Neat PCM” test in Row #9, cycling was inconsistent. Regarding the tests summarized in Row #11, cycling the “Neat PCM” resulted in significant supercooling. The “Co-Cure: PCM+Foam” test was not completed due safety concerns. The “Foam 103A” test resulted in the loss of thermal storage and bad cycling. The “1.5% Laponite” and “3% Laponite” tests resulted in no loss of thermal storage and less super cooling. The “4.5% Laponite” test resulted in the loss of thermal storage and broad melting and crystallization peaks in the DSC spectra. Laponite and SrCl₂ are exemplary additives, as described herein. (“Laponite” refers to Laponite 482S™.)

TABLE 6
Summary of PCM Cycling Experiments

| | | | Co-Cure: | | | | | | | |
|---|---|---|---|---|---|---|---|---|---|---|
| | | Neat | PCM + | Foam | 1.5% | 3% | 4.5% | 2% | 4% | 6% |
| # | PCM | PCM | Foam | 103A | Laponite | Laponite | Laponite | SrCl₂ | SrCl₂ | SrCl₂ |
| 1 | Heptadecane | Yes | | Yes | Yes | Yes | | | | |
| | | (cycled) | | (cycled) | (cycled) | (cycled) | | | | |
| 2 | Na₂SO₄ | Yes (1) | Incomplete | Yes (0) | | | | | | |
| | | | cure | | | | | | | |
| 3 | Na₂SO₄ w/ | | | Yes (2) | | | | | | |
| | 5% H₂O | | | | | | | | | |
| 4 | 85% Na₂SO₄, | | | Yes (0) | Yes (0) | | | | | |
| | 10% H₂O, | | | | | | | | | |
| | 5% Borax | | | | | | | | | |
| 5 | 70% Na₂SO₄, | | | Yes (0) | Yes (0) | | | | | |
| | 25% H₂O, | | | | | | | | | |
| | 5% Borax | | | | | | | | | |
| 6 | Xylitol | Yes (1) | Incomplete | Yes (1) | Yes (1) | | | | | |
| | | | cure | | | | | | | |
| 7 | Xylitol w/ | | | Yes (0) | | | | | | |
| | 5% ethanol | | | | | | | | | |
| 8 | Xylitol w/ | | | Yes (1) | Yes (1) | | | | | |
| | 5% glycerol | | | | | | | | | |
| 9 | CaCl₂ | Yes (2) | No cure | Yes (0) | Yes (0) | | | Yes (2) | Yes (2) | Yes (2) |
| 10 | CaCl₂ w/ | | | Yes (0) | Yes (0) | | | | | |
| | 3% SrCl₂ | | | | | | | | | |
| 11 | Mg(NO₃)₂ | Yes (2) | | Yes (1) | Yes (2) | Yes (2) | Yes (0) | | | |

“Yes” = tested; (#) indicates number of times cycled; “Foam 103A” and all other tests to the right were completed using vacuum infusion. “Foam 103A” refers to the formulation used to synthesize the foam illustrated in FIG. 4.

All of the PHU foams listed in the table were synthesized using the components shown in Reaction 1, as well as 0.1 eq DBU and 0.1 eq TBAB, following the generalized procedure shown in FIG. 3 and described above. On the left-most column is labeled the tested PCM, and in the top-most row is listed the solid additive in the PHU. Curing the foam in the presence of the PCM resulted in a poorly cured material with unfavorable properties. Foams without any additives (103A) did not demonstrate any improved performance and cycling stability. Foams with a synthetic smectic clay showed some ability to stabilize PCM cycling, although with inconsistent results. Foams with SrCl₂·6H₂O showed consistent cycling with CaCl₂·6H₂O PCM. These data illustrated that the addition of a suitable additive is imperative to the cycling stability of the PCM within the PHU foam composite, due to its ability to nucleate crystallization of the PCM.

FIG. 4 illustrates additional examples of PHU foams synthesized using varying amounts of cyclic-carbonate (TMPTC), amine (putrescine), thiol (2,2′-(Ethylenedioxy)diethanethiol), and additives (only Test #'s 103C, top and bottom, used 1.5 wt % Laponite), according to some embodiments of the present disclosure. Table 7 summarizes the amounts of reactants and catalysts used to synthesize each PHU foam illustrated in FIG. 4, as well as the amount of time the samples were stirred by hand (Time #1), followed by the amount of time stirred by asymmetric centrifugation at 3000 RPM (Time #2). Each experiment used 0.1 equivalents of DBU and 0.1 equivalents of TBAB as catalysts.

TABLE 7
PHU Foam Synthesis Conditions for Foams Shown in FIG. 4

| | Carbonate | Amine | Thiol | Amine:Thiol | Carb.:(Amine + | Time #1 | Time #2 |
|---|---|---|---|---|---|---|---|
| Test # | (eq) | (eq) | (eq) | ratio | Thiol) ratio | (min) | (min) |
| 103A top | 1.0 | 1.075 | 0.4 | 2.7:1 | 0.68:1 | 10 | 10 |
| 103A bottom | 3.0 | 2.15 | 0.8 | 2.7:1 | 1.01:1 | 10 | 10 |
| 103B top | 1.0 | 1.05 | 0.425 | 2.5:1 | 0.68:1 | 10 | 10 |
| 103B bottom | 3.0 | 2.1 | 0.85 | 2.5:1 | 1.01:1 | 10 | 10 |
| 103C top | 1.0 | 1.075 | 0.4 | 2.7:1 | 0.68:1 | 10 | 10 |
| 103C bottom | 3.0 | 2.15 | 0.8 | 2.7:1 | 1.01:1 | 10 | 10 |
| 103D top | 1.0 | 1.025 | 0.45 | 2.3:1 | 0.68:1 | 30 | 10 |
| 103D bottom | 3.0 | 2.05 | 0.9 | 2.3:1 | 1.01:1 | 30 | 10 |

Test #'s 103A and 103B show thiol concentration plays a role in foam morphology. Test #103D shows that the thiol concentration can be increased and still achieve a good uniform foam morphology as long as the viscosity is increased by increasing the precure time (30 minutes stirred by hand, 10 minutes by asymmetric centrifugation at 3000 rpm). This resulted in a less dense foam, showing some degree of tunability. Sample 103C shows that by adding 1.5 wt % additive of Laponite, a good uniform foam morphology can still be achieved, even with a solid additive distributed throughout the PHU composition. No PCM was used in these compositions.

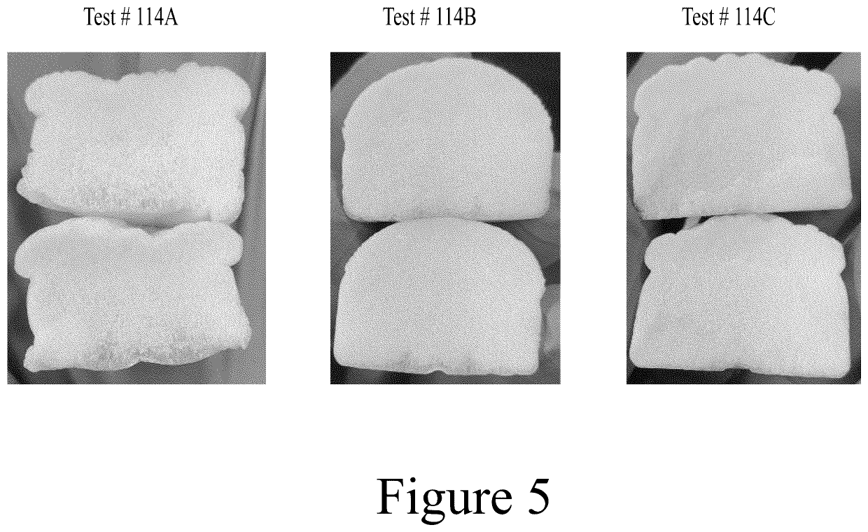

FIG. 5 illustrates that as the weight percent of additive was increased, one may also need to increase the thiol concentration to compensate, according to some embodiments of the present disclosure. These experiments used TMPTC (carbonate), putrescine (amine), and 2,2′-(ethylenedioxy)diethanethiol (thiol), each with 0.1 equivalents of DBU and 0.1 equivalents of TBAB as catalysts. Additives can act as a source of air bubble nucleation, and, therefore, high additive contents generally resulted in a denser foam structure. Thus, thiol or blowing agent, typically may need to be increased to compensate to produce less dense foam compositions. Table 8 summarizes the amounts of reactants and catalysts used for each foam sample illustrated in FIG. 5.

TABLE 8
PHU Foam Synthesis Conditions for Foams Shown in FIG. 5

| | Carbonate | Amine | Thiol | Amine:Thiol | Carb.:(Amine + | Laponite |
|---|---|---|---|---|---|---|
| Run | (eq) | (eq) | (eq) | ratio | Thiol) ratio | (wt %) |
| 114A top | 1.0 | 1.025 | 0.45 | 2.28:1 | 0.68:1 | 1.5 |
| 114A bottom | 3.0 | 2.05 | 0.9 | 2.28:1 | 1.02:1 | 1.5 |
| 114B top | 1.0 | 1.025 | 0.45 | 2.28:1 | 0.68:1 | 3.0 |
| 114B bottom | 3.0 | 2.05 | 0.9 | 2.28:1 | 1.02:1 | 3.0 |
| 114C top | 1.0 | 1.025 | 0.45 | 2.28:1 | 0.68:1 | 4.5 |
| 114C bottom | 3.0 | 2.05 | 0.9 | 2.28:1 | 1.02:1 | 4.5 |

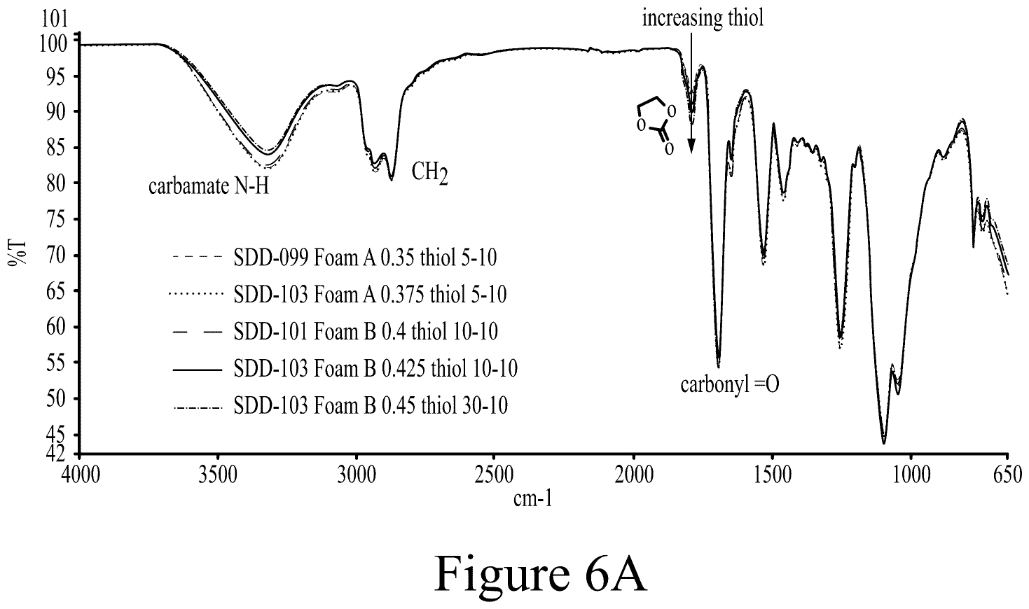

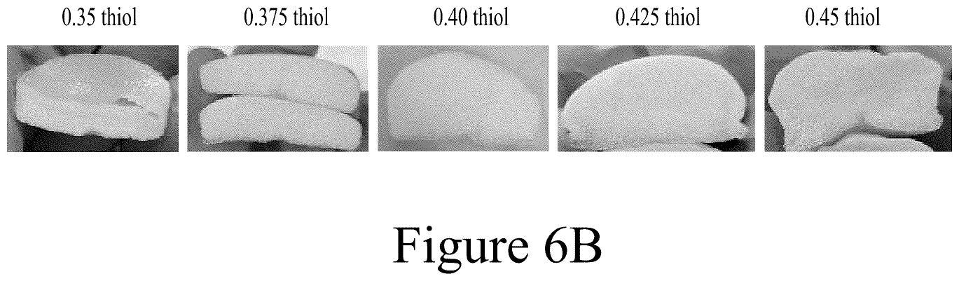

FIG. 6A illustrates IR spectra showing that adjusting the thiol:amine ratio slightly modified the ratio of carbamate:thioether linkages observed in the final PHU product, according to some embodiments of the present disclosure. FIG. 6B illustrates photos of the resultant foams. From the peak at 3300 cm¹, the intensity of the carbamate N—H peak increased as the ratio of amine:thiol equivalents increased.

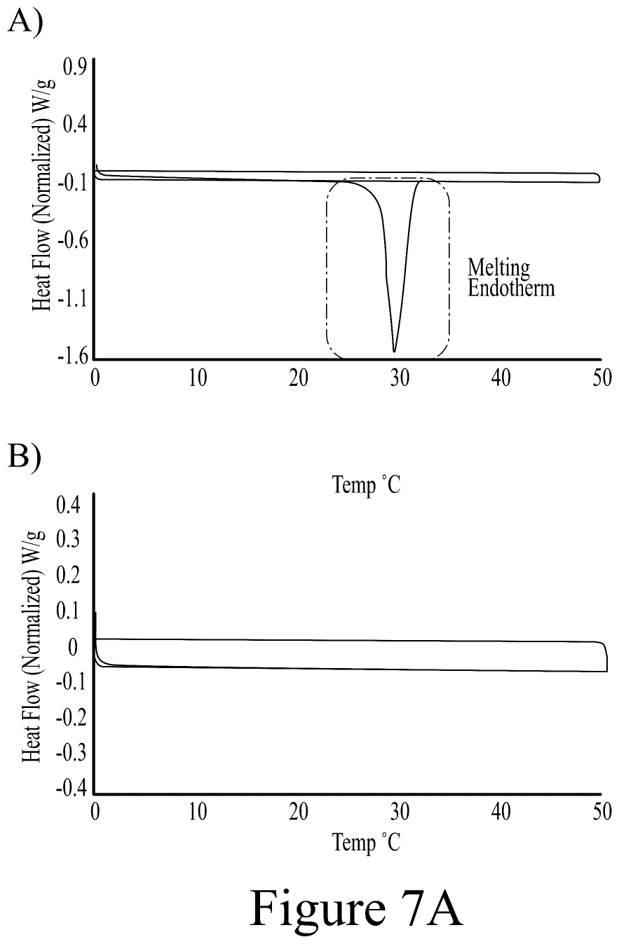

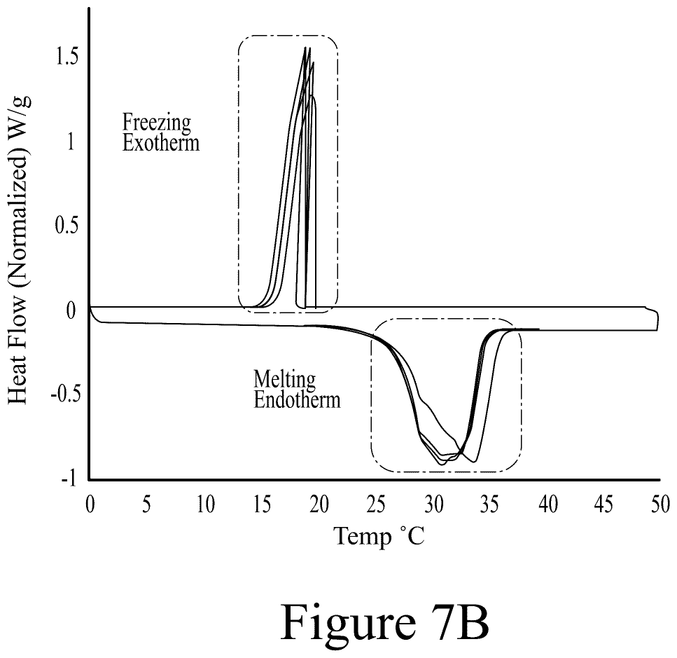

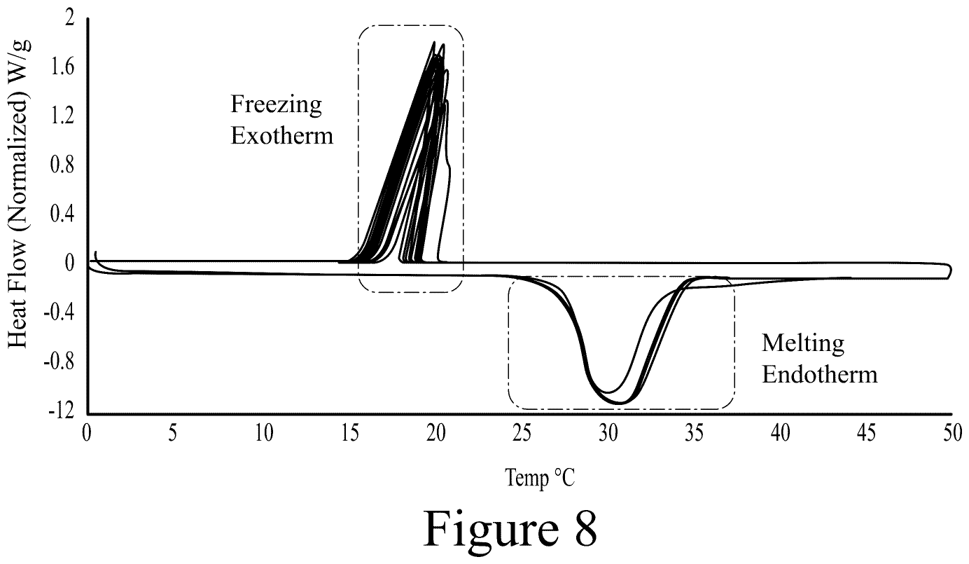

FIGS. 7A and 7B illustrate additional experimental results, according to some embodiments of the present disclosure. Two foams (using the carbonate (TMPTC), amine (TMD), thiol (EDT), and catalysts (DBU and TBAB)) were synthesized using the same components, except that one was synthesized with 5 wt % barium carbonate (see FIG. 7B), present during the cure/foaming of the PHU, and one without any additives (see FIG. 7A). Once cured, the foams were infused with a melted CaCl₂ 6H₂O under vacuum at 50° C. Vacuum was applied and released, for multiple cycles, over the course of 30 minutes to ensure good distribution of the melted PCM into the pores of the foam. The foams were removed from the melted PCM and left in the ambient conditions to cool for 10 minutes prior to completing the DSC analysis. The Panel A of FIG. 7A illustrates that neat calcium chloride hexahydrate, without any foam or stabilizing additive melted on the first heating cycle (from 0° C. to 50° C., 2 degrees per minute). Upon cooling (from 50° C. to 0° C., 1 degree per minute), however, the neat CaCl₂ 6H₂O did not refreeze. Because it did not freeze, as indicated by the absence of a freezing exotherm in the DSC plot, it was unable to melt again in the second cycle. A DSC plot of the CaCl₂-6H₂O in a foam without any additive is shown Panel B of FIG. 7A. As one can observe, the PCM did not recrystallize inside of the foam, thus no melt endotherm or freezing exotherm were observed. A DSC plot of the CaCl₂-6H₂O in a 5 wt % BaCO₃ foam is shown in FIG. 7B. This shows that the CaCl₂-6H₂O melted and refroze consistently every cycle for 6 cycles without any loss of energy storage. A similar performance was demonstrated for 50+ cycles as shown in FIG. 8. Furthermore, neat CaCl₂·6H₂O presented an endotherm of 186 J/g, and the 5 wt % BaCO₃-containing foam with CaCl₂·6H₂O presented endotherms between 139.5 J/g and 142.9 J/g per cycle, meaning it stored nearly 75% as much energy as the neat material without any loss of energy observed with each cycle.

Referring again to FIG. 8, the foam was synthesized with 5 wt % BaCO₃ using the procedure for foam thermoset synthesis described above, according to some embodiments of the present disclosure. The foam was synthesized using the 1.0 equivalent of carbonate (TMPTC), to 1.0125 equivalents of amine (TMD), to 0.45 equivalents of thiol (EDT), and catalysts (0.1 equivalents of DBU and 0.1 equivalents of TBAB). The foam was infused with CaCl₂·6H₂O and monitored by differential scanning calorimetry (0-50° C. sweeps, 50+ cycles, 2° C./min heating, 1° C./min cooling). At an onset temperature of 27° C., the PCM melted with a consistent enthalpy of fusion demonstrated for all 50 cycles with a range between 138 J/g and 140 J/g. Further, an exothermic crystallization was observed at about 18° C. for each of the 50 cycles.

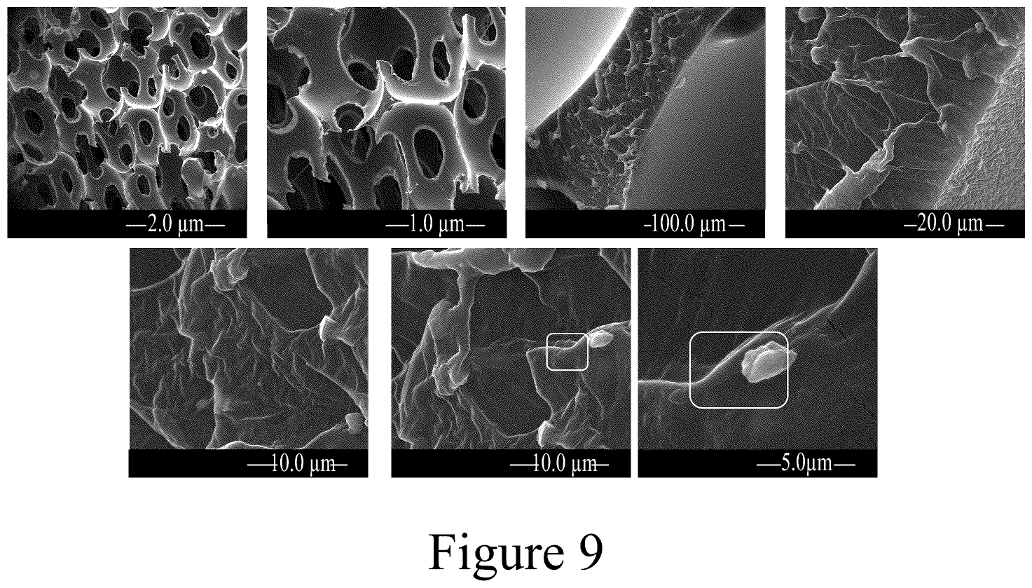

FIG. 9 illustrates scanning electron micrographs (SEMs) of exemplary PHU foams with BaCO₃ distributed within the foams, according to some embodiments of the present disclosure. BaCO₃ particles can be observed embedded in the foam structure. These images correspond to the PHU foams described above for FIG. 8.

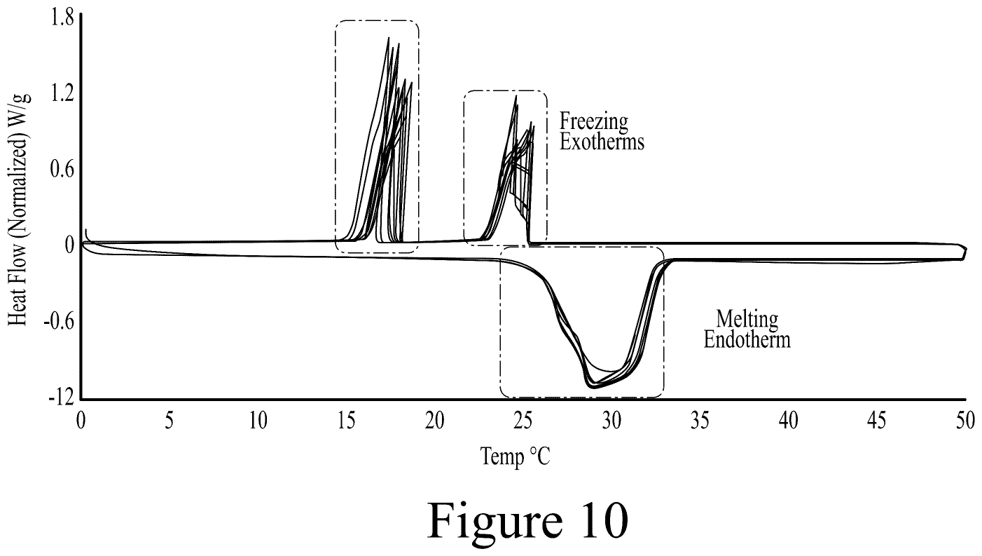

FIG. 10 illustrates DSC plots of an exemplary PHU foam containing 5% BaCO₃ and a combination of two PCMs, CaCl₂·6H₂O and octadecane, at a 2:1 ratio of CaCl₂·6H₂O to octadecane. This resulted in the PHU foam demonstrating one melting point with an onset temperature of about 26° C. (with an enthalpy of about 140 J/g) and two freezing points, a first having an onset temperature of about 18° C. (with an enthalpy of about 67 J/g due to the CaCl₂·6H₂O) and a second onset temperature at about 25° C. (enthalpy of about 63 J/g due to the octadecane), according to some embodiments of the present disclosure. DSC was completed successfully with 20 cycles, with swings between 0° C. and 50° C. This study was performed as a control, showing that other additives, or foams without additives, do not stabilize CaCl₂ PCM.

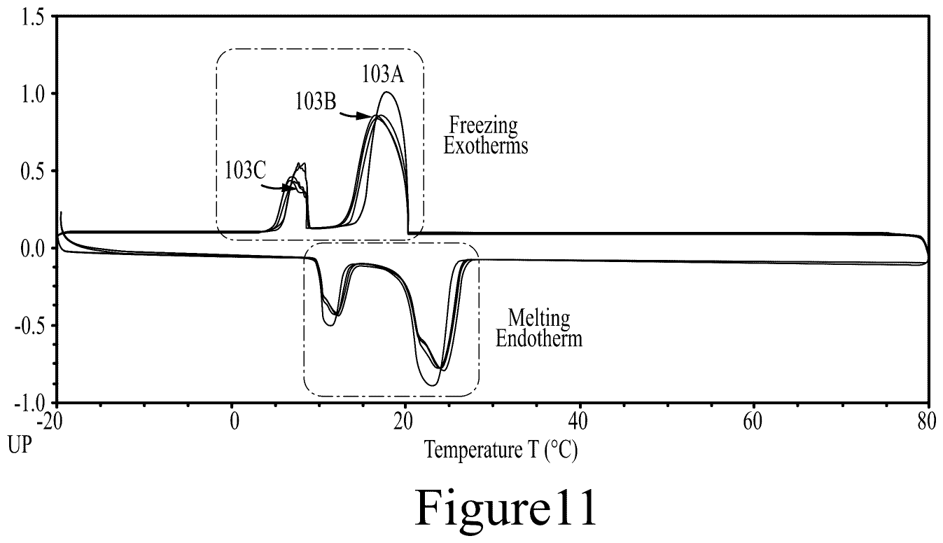

FIG. 11 illustrates DSC data of various PHU foams infused with the heptadecane, according to some embodiments of the present disclosure. The same PHU recipes were used as summarized in Table 7 above, with the addition of ˜50 wt % heptadecane. Good loading and good cycling stability were demonstrated, as observed by the high heats of fusion and repeated cycling. Table 9 summarizes the recipes used and corresponding freezing enthalpies measured for each.

TABLE 9
Foam Infused with Heptadecane

| Recipe from | Thiol | Lamponite | Freezing Enthalpy |
|---|---|---|---|
| Table 7 | (eq) | (wt %) | (J/g) |
| 103A | 0.4 | 0 | 102.6 |
| 103B | 0.425 | 0 | 102.0 |
| 103C | 0.4 | 1.0 | 98.1 |

An exemplary PHU foam was infused with xylitol as the PCM, according to some embodiments of the present disclosure. This composition did not perform well as no stable cycling was observed. Xylitol is highly viscous, which can prevent rearrangement of the molecules to the unit cell at lower temperatures, making spontaneous primary/secondary nucleation unlikely.

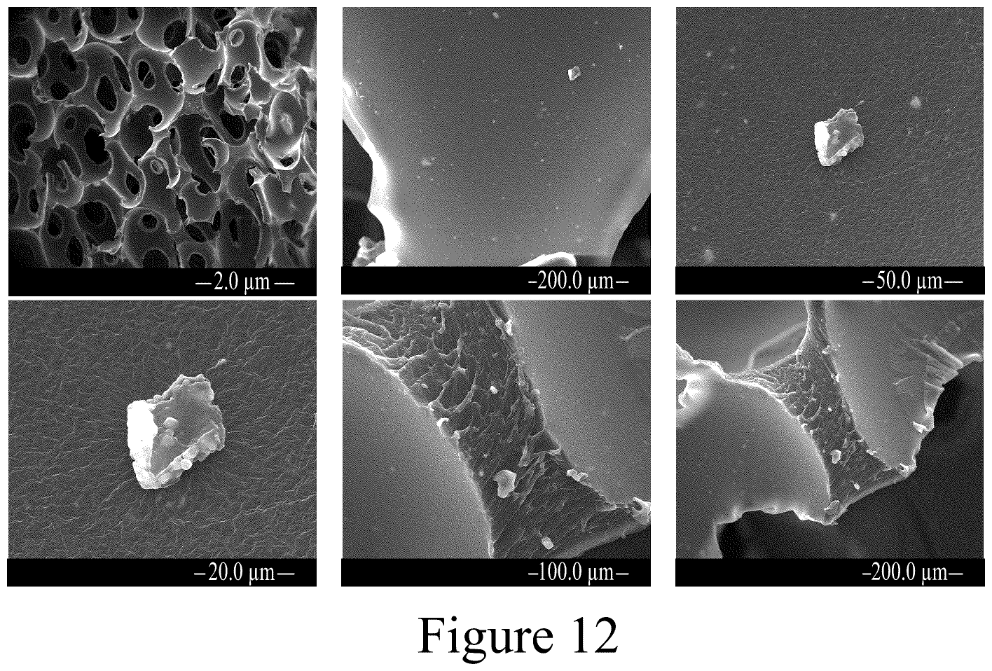

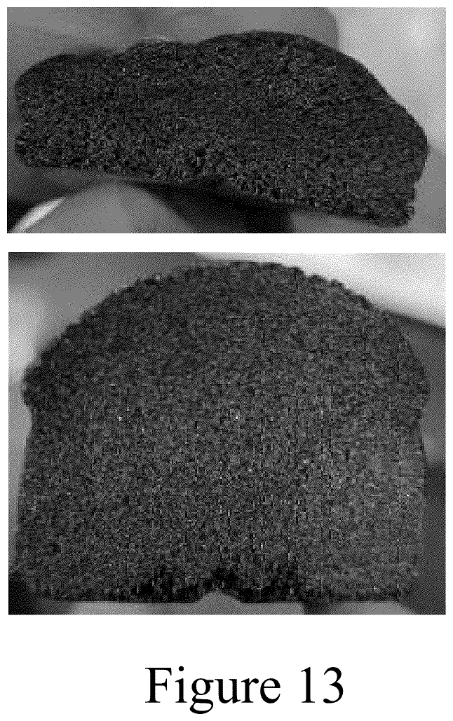

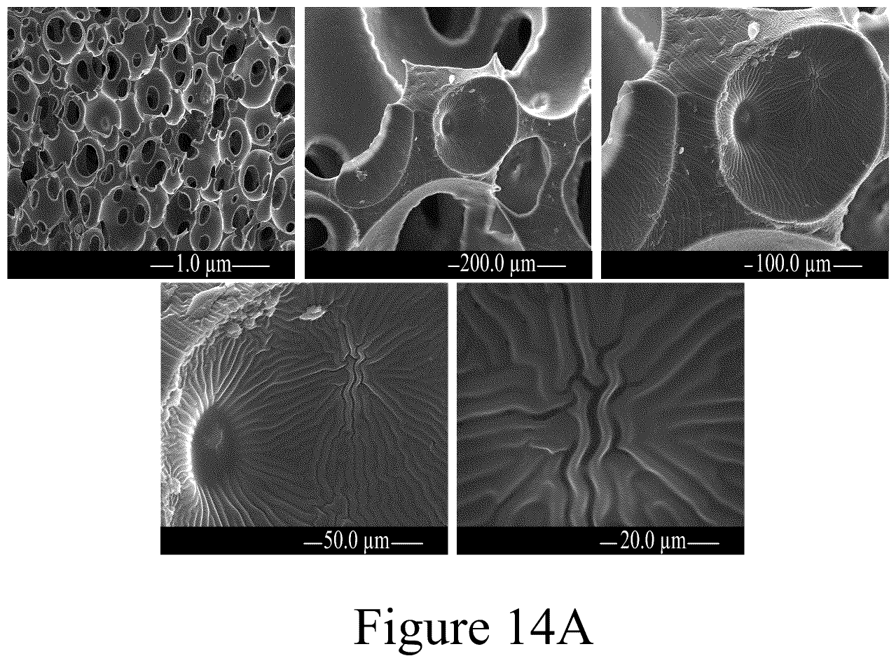

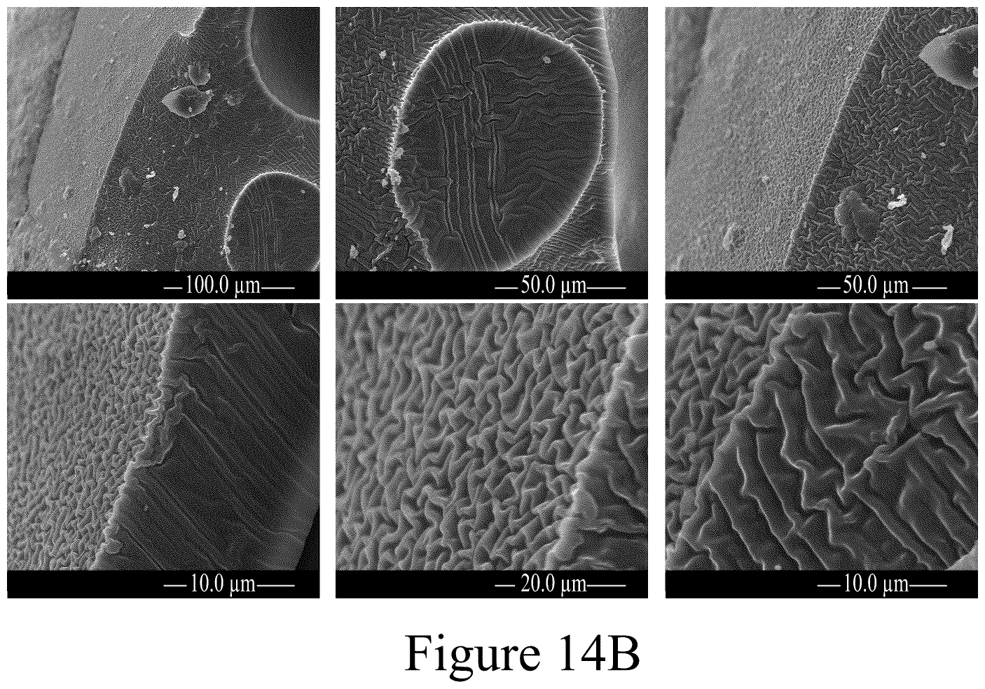

PHU foam samples from the experiments reported above, using heptadecane as a PCM demonstrated minimal leaking of the PCM from the foams, indicating that the PHU foam compositions maintain good retention of the PCM. FIG. 12 illustrates additional SEM images of PHU foam compositions containing 1.4 wt % BaCO₃, according to some embodiments of the present disclosure. FIG. 13 illustrates foam samples incorporating different amounts of graphite powder (200 mesh) additive, 3 wt % (top) and 1.5 wt % (bottom), according to some embodiments of the present disclosure. Graphite can be used as an additive for PHU composites as a means to increase thermal conductivity as well modulate mechanical properties. Controlling the rate of ambient heat transfer to a PCM is important for various applications. The PHU composition utilized in these samples corresponds to 1 equivalent of carbonate (TMPTC), 1.025 equivalents of amine (TMD), and 0.45 equivalents of thiol (EDT) (with 0.1 equivalents of DBU catalyst and 0.1 equivalents of TBAB catalyst). FIGS. 14A and 14B illustrate SEM images of PHU samples containing 1.5 wt % graphite powder.

FIGS. 15A-15H illustrate rheology data obtained from different PHU foam samples, according to some embodiments of the present disclosure. These were obtained using a parallel plate rheometer having 25 mm diameter plates. The gap between the plates was set between 1,000 m and 1,500 m. Tests were completed with zero N axial force and a constant strain of 2.5% while heating up to a target temperature of 90° C. and a constant strain of 1.0% while maintaining the target temperature. G′ represents storage modulus and G″ represents loss modulus. The temperature at which the two curves (for G′ and G″) cross represents the corresponding gel point temperature, T_{gel}, for a particular sample. All of the samples were synthesized using TMPTC (carbonyl), EDT (thiol), and TMD (amine), and both catalysts TBAB and DBU. The recipes for each foam and the resultant G′, G″, T_{gel} are summarized in Table 10. Each test used 0.100 equivalents of TBAB and 0.100 equivalents of DBU. Further, each test used 0.500 equivalents of Vorasurf 5986™ surfactant. None of these tests utilized a PCM. Only the last test, corresponding to FIG. 15H, utilized an additive, 5 wt % of BaCO₃.

TABLE 10
Storage Modulus, Loss Modulus, and Gel Points for PHU Foams

| | TMPTC | TMD | EDT | TMD:EDT | TMPTC:(TMD + | T_{gel} | G′ | G″ |
|---|---|---|---|---|---|---|---|---|
| Test | (eq) | (eq) | (Eq) | ratio | EDT) ratio | (° C.) | (MPa) | (MPa) |
| FIG. 15A (A) | 1.000 | 0.000 | 1.500 | 0 | 0.67:1 | >120 | 0.005 | 0.005 |
| FIG. 15A (B) | 1.000 | 1.500 | 0.000 | NA | 0.67:1 | 10 | 0.66 | 0.03 |
| FIG. 15A (C) | 1.000 | 1.025 | 0.450 | 2.28:1 | 0.68:1 | 22 | 1.56 | 0.25 |
| FIG. 15B (A) | 1.000 | 1.025 | 0.450 | 2.28:1 | 0.68:1 | 38 | 0.08 | 0.004 |
| FIG. 15B (B) | 1.000 | 1.025 | 0.450 | 2.28:1 | 0.68:1 | 22 | 1.56 | 0.25 |
| FIG. 15B (C) | 1.000 | 1.025 | 0.450 | 2.28:1 | 0.68:1 | 14 | 3.16 | 0.43 |
| FIG. 15C (A) | 1.000 | 1.025 | 0.450 | 2.28:1 | 0.68:1 | 22 | 1.56 | 0.25 |
| FIG. 15C (B) | 1.000 | 1.025 | 0.450 | 2.28:1 | 0.68:1 | 15 | 0.97 | 0.05 |

Referring to FIG. 15A, the absence of an intersection of the G′ curve and the G″ curve indicates that a reaction between the thiol and the carbonate does not take place in the absence of the amine. Further, comparing FIG. 15C to FIG. 15B, the gel point is delayed in FIG. 15C due to the generation of CO₂ gas resulting from the reaction of the thiol and the carbonate. FIG. 15C illustrates a gel point occurring after about 22 minutes of reaction versus a gel point occurring after about only 10 minutes of reaction in the example illustrated in FIG. 15B. Referring to FIGS. 15D-15F, these experiments illustrate that the time of gelation and T_{gel} can be tuned by the PHU recipe selected. The data illustrated in FIGS. 15D, 15E, and 15F demonstrate T_{gel} values of about 80° C., about 90° C., and about 100° C., respectively, with gel times occurring at about 38 minutes, about 22 minutes, and about 14 minutes, respectively. Referring to FIGS. 15G and 15H, these data sets indicate that the addition of 5 wt % BaCO₃, while important for producing a foam having good cycling characteristics when using a PCM, the addition of BaCO₃ had no significant effect on the foaming kinetics. FIG. 16 illustrates thermal conductivity data obtained from different PHU foam samples, according to some embodiments of the present disclosure. The PHU recipe for these tests was as follows: TMPTC—1.0 equivalents; EDT—0.45 equivalents; TMD—1.025 equivalents; TBAB=DBU 0.1 equivalents; Vorasurf 5986=0.500 equivalents. These data illustrate that the thermal conductivity of PHU foams can be adjusted with the use of additives like graphite. Specifically, the thermal conductivity of the resultant PHU without any additive varied between 0.182 W/mK and 0.192 W/mK, with 1.5 wt % graphite between 0.187 W/mK and 0.193 W/mK, and with 5 wt % BaCO₃ between 0.167 W/mK and 0.177 W/mK, over a temperature range from about 0° C. to about 105° C.

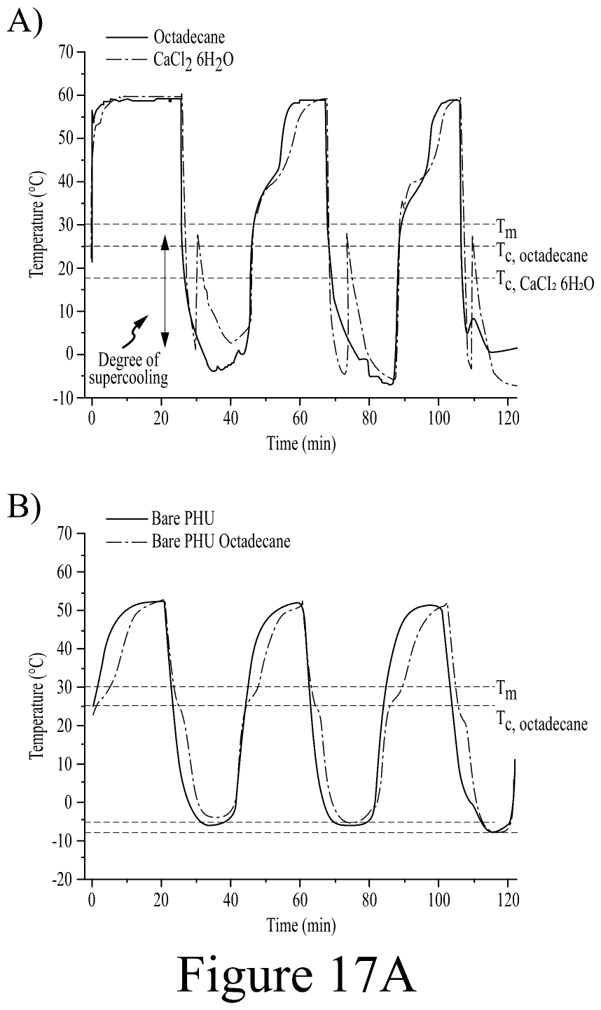

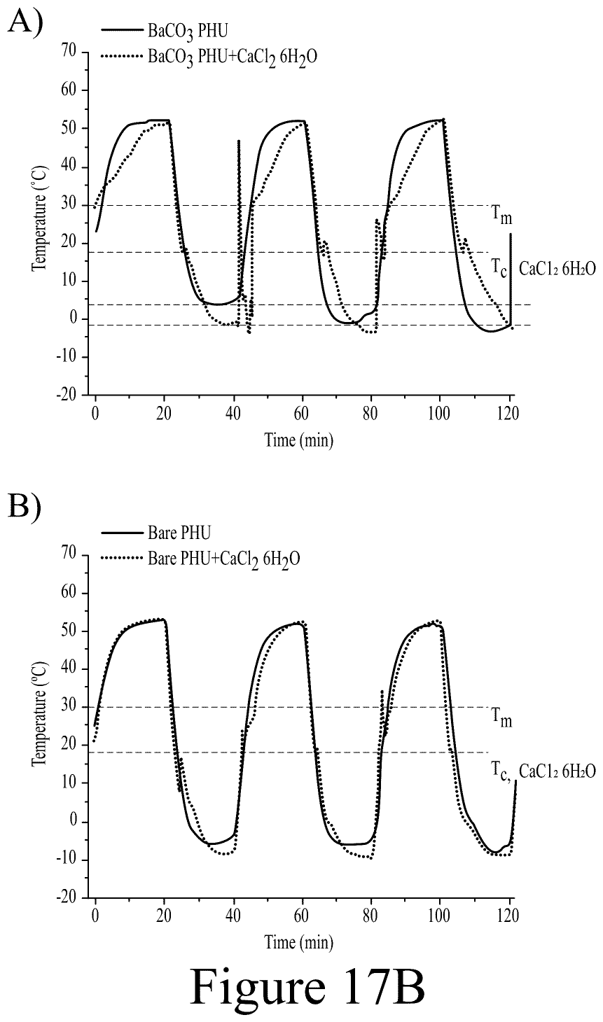

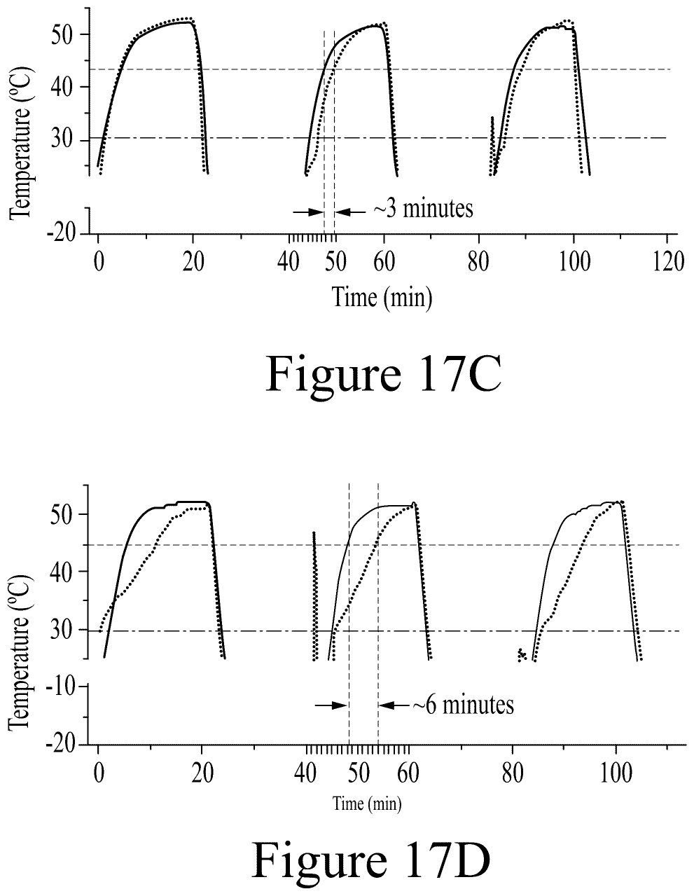

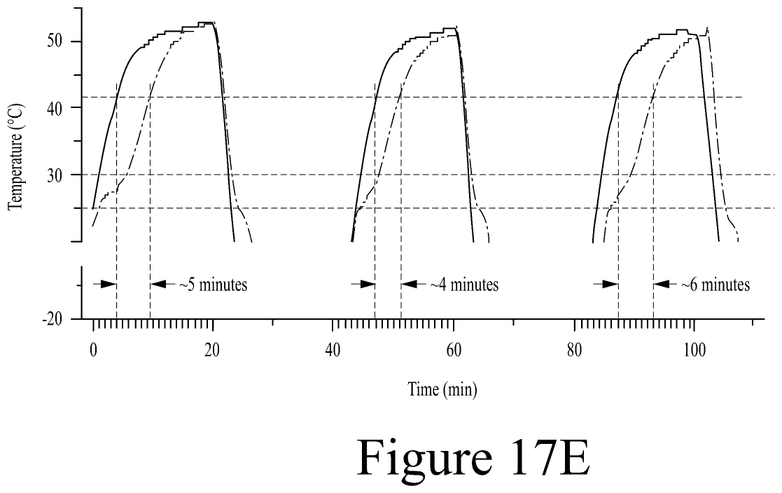

FIGS. 17A and 17B illustrate temperature and phase change data obtained from different PHU foam samples, according to some embodiments of the present disclosure. The PHU recipes used for the samples summarized in these two figures are tabulated in Table 11 below. The surfactant used in these tests was Vorasurf 5986™.

TABLE 11
Temperature and Phase Change Data for PHU Samples

| | TMPTC | TMD | EDT | | TMPTC:(TMD + | TBAB | DBU | | Additive | Surfactant |
|---|---|---|---|---|---|---|---|---|---|---|
| Test | (eq) | (eq) | (Eq) | TMD:EDT | EDT) | (eq) | (eq) | PCM | (wt %) | (eq) |
| Octadecane | 0 | 0 | 0 | NA | NA | 0 | 0 | Octadecane | 0 | 0 |
| CaCl₂ 6H₂O | 0 | 0 | 0 | NA | NA | 0 | 0 | CaCl₂•6H₂O | 0 | 0 |
| Bare PHU | 1.000 | 1.025 | 0.450 | 2.28:1 | 0.68:1 | 0.100 | 0.100 | | 0 | |
| Bare PHU | 1.000 | 1.025 | 0.450 | 2.28:1 | 0.68:1 | 0.100 | 0.100 | Octadecane | 0 | 0.500 |
| Octadecane | | | | | | | | | | |
| BaCO₃ PHU | 1.000 | 1.025 | 0.450 | 2.28:1 | 0.68:1 | 0.100 | 0.100 | none | 5 | 0.500 |
| | | | | | | | | | BaCO₃ | |
| BaCO₃ PHU + | 1.000 | 1.025 | 0.450 | 2.28:1 | 0.68:1 | 0.100 | 0.100 | CaCl₂•6H₂O | 5 | 0.500 |
| CaCl₂ 6H₂O | | | | | | | | | BaCO₃ | |
| Bare PHU | 1.000 | 1.025 | 0.450 | 2.28:1 | 0.68:1 | 0.100 | 0.100 | none | 0 | 0.500 |
| Bare PHU + | 1.000 | 1.025 | 0.450 | 2.28:1 | 0.68:1 | 0.100 | 0.100 | CaCl₂•6H₂O | 0 | 0.500 |
| CaCl₂ 6H₂O | | | | | | | | | | |

Temperature cycling was achieved using a heating block for heating and a dry ice/ethylene glycol cooling bath for cooling. Samples were prepared as follows: PHU foam samples were synthesized in 20 ml glass vials using the synthesis method described above. About 1.5 grams of PHU foam were produced per test. Liquid PCM at about 60° C. (octadecane or CaCl₂-6H₂O) was then injected directly into the PHU foam, resulting in PCM infused PHU foam. This PCM infused PHU foam was then heated to about 60° C. and maintained at that temperature for about 20 minutes before being cooled to about −10° C. and again maintained at that temperature for about 20 minutes, resulting in a first cycle of the composite material being tested. The same protocol was performed on “bare PHU” (e.g., no PCM or additive present in the PHU foam) and on pure PCM (e.g., just octadecane or CaCl₂-6H₂O).

Referring again to FIGS. 17A and 17B, materials that demonstrate an off-set in the temperature-time cycling curve for the pure PHU material versus the temperature-time cycling curve obtained for the same PHU material with infused PCM is desirable. Panel A of FIG. 17A illustrates the cycling curves obtained for the pure PCMs tested, octadecane or CaCl₂·6H₂O. These curves illustrate T_{c} and Tₘ values for each PCM, which are summarized in Table 12 below.

TABLE 12
PCM Melt and Crystallization Temperatures

| PCM | T_{c} (° C.) | Tₘ (° C.) |
|---|---|---|
| octadecane | 25 | 28 |
| CaCl₂•6H₂O | 17 | 31 |

Panel B of FIG. 17B, for pure PHU versus PHU infused with CaCl₂·6H₂O, illustrates an example of where the off-set in the temperature-time cycling curves is minimal and less than desired. FIG. 17C provides a magnified view of the melting portion of these curves. This shows that the maximum time offset occurs during the second cycle, where the CaCl₂·6H₂O infused PHU curve lags the pure PHU curve by about 3 minutes. FIG. 17D illustrates the very significant impact of adding BaCO₃ to the PHU foam CaCl₂-6H₂O composite. The maximum offset occurring during the second cycle is increased from about 3 minutes (in the absence of BaCO₃) to about 6 minutes. So, the addition of BaCO₃ to the PHU foam CaCl₂-6H₂O composite results in about double the time offset in melting the PCM. Further, referring again to FIG. 17D, the PHU foam/CaCl₂·6H₂O/BaCO₃ composite demonstrates a relatively repeatable offset of about 6 minutes for all three cycles illustrated. This system also shows time delays during the freezing portion of all three cycles; they are just not as easy to quantify using a simple time offset. Referring again to Panel A of FIG. 17B, the combination of BaCO₃ and CaCl₂·6H₂O in the PHU foam can result in an appreciable reduction in supercooling, as the minimum temperatures achieved during the freezing portions of the curves are offset by about 5 degrees Celsius, at least for the first and second cycles.

FIG. 17E illustrates that the PCM octadecane provides a desired offset without the need for an additional additive. In this example, the maximum time offset between the pure PHU temperature-time cycling curve versus the curve resulting from the addition of octadecane occurs during the third cycle, with a time offset of about 6 minutes. The average time offset for the three cycles illustrated in FIG. 17E is about 5 minutes. This system also shows time delays during the freezing portion of all three cycles; they are just not as easy to quantify using a simple time offset. Referring again to Panel B of FIG. 17A, the use of octadecane does not result in an appreciable reduction in supercooling, as the minimum temperatures achieved during the freezing portions of the curves occur at about the same point, at about −5° C. for the first and second cycles, and slightly lower at about −8° C. during the third cycle.

### EXAMPLES

Example 1. A composition comprising: a poly(hydroxy)urethane (PHU) foam; a phase change material (PCM); and a solid additive, wherein: the PHU foam comprises a plurality of voids, at least a portion of the voids contain the PCM and the solid additive, and the composition is capable of being repeatedly cycled through a temperature range, resulting in the PCM cycling between a solid phase and a liquid phase.

Example 2. The composition of Example 1, wherein the PCM comprises at least one of a hydrated salt, a paraffin wax, a sugar alcohol, a fatty acid, or a eutectic mixture.

Example 3. The composition of either Example 1 of Example 2, wherein the hydrated salt comprises at least one of calcium chloride hexahydrate (CaCl₂·6H₂O), Na₂SO₄·10H₂O, Na₂HPO₄·12H₂O, Na₂S₂O₃·5H₂O, CH₃COONa·3H₂O, KF·4H₂O, LiNO₃·3H₂O, or (Na₂[B₄O₅(OH)₄]·8H₂O).

Example 4. The composition of any one of Examples 1-3, wherein the paraffin wax comprises a linear long chain hydrocarbon.

Example 5. The composition of any one of Examples 1-4, wherein the linear long chain hydrocarbon comprises at least one of tetradecane, pentadecane, hexadecane, heptadecane, octadecane, nonadecane, or icosane.

Example 6. The composition of any one of Examples 1-5, wherein the sugar alcohol comprises at least one of xylitol, sorbitol, erythritol, maltitol, isomalt, or lactitol.

Example 7. The composition of any one of Examples 1-6, wherein the fatty acid comprises at least one of palmitic acid or stearic acid.

Example 8. The composition of any one of Examples 1-7, wherein the PCM is present at a concentration 0 wt %<x≤85 wt %.

Example 9. The composition of any one of Examples 1-8, wherein 40 wt %<x≤75 wt %.

Example 10. The composition of any one of Examples 1-9, wherein the PCM has a heat of fusion 50 J/g≤H≤250 J/g.

Example 11. The composition of any one of Examples 1-10, wherein 80 J/g≤H≤150 J/g.

Example 12. The composition of any one of Examples 1-11, wherein the solid additive comprises at least one of a carbonate salt, a metal oxide, a clay, a zeolite, or a carbonaceous material.

Example 13. The composition of any one of Examples 1-12, wherein the carbonate salt comprises at least one of BaCO₃ or Ba₂SO₄.

Example 14. The composition of any one of Examples 1-13, wherein the metal oxide comprises at least one of TiO₂, MgO, Al₂O₃, SiO₂, or BaO₂.

Example 15. The composition of any one of Examples 1-14, wherein the clay comprises at least one of celite or montmorillonite.

Example 16. The composition of any one of Examples 1-15, wherein the carbonaceous material comprises at least one of graphene, graphite, carbon nanotubes, or activated charcoal.

Example 17. The composition of any one of Examples 1-16, wherein the carbonaceous material comprises graphite and the composition has a thermal conductivity between 0.18 W/mK and 0.195 W/mK

Example 18. The composition of any one of Examples 1-17, wherein the solid additive is present at a concentration 0 wt %<y≤10 wt %.

Example 19. The composition of any one of Examples 1-18, wherein 1.5 wt %<y≤5 wt %.

Example 20. The composition of any one of Examples 1-19, wherein the PHU is derived from reacting a cyclic carbonate-containing molecule with an amine-containing molecule and a thiol-containing molecule.

Example 21. The composition of any one of Examples 1-20, wherein the cyclic carbonate-containing molecule comprises a cyclic carbonate group.

Example 22. The composition of any one of Examples 1-21, wherein the cyclic carbonate-containing molecule comprises at least one of trimethylpropane tricarbonate (TMPTC), 4,4′-1[1,4-cyclohexanediylbis (methyleneoxymethylene)]bis [1,3-dioxolan-2-one], 4,4′-[1,6-hexanediylbis (oxymethylene)]bis [1,3-dioxolan-2-one], 4,4′-[1,2-Ethanediylbis(oxymethylene)]bis [1,3-dioxolan-2-one], or ,4′-[1,4-butanediylbis(oxymethylene)]bis[1,3-dioxolan-2-one].

Example 23. The composition of any one of Examples 1-22, wherein the amine-containing molecule comprises at least one of spermidine, putrescine (TMD), spermine, cadaverine, or m-xylene diamine.

Example 24. The composition of any one of Examples 1-23, wherein the thiol-containing molecule comprises 2,2′-(ethylenedioxy)diethanethiol (EDT), decanethiol, or pentaerythritol tetrakis(3-mercaptopropionate).

Example 25. The composition of any one of Examples 1-24, wherein the cyclic carbonate-containing molecule comprises TMPTC, the amine-containing molecule comprises TMD, and the thiol-containing molecule comprises EDT.

Example 26. The composition of any one of Examples 1-25, wherein the PHU is derived using a starting ratio of diamine to thiol between 10:1 and 1:1.

Example 27. The composition of any one of Examples 1-26, wherein the starting ratio of diamine to thiol is between 2.25:1 and 3.5:1.

Example 28. The composition of any one of Examples 1-27, wherein the starting ratio of diamine to thiol is between 2.26:1 and 2.8:1.

Example 29. The composition of any one of Examples 1-28, wherein the PHU is derived using a starting ratio of carbonate to amine plus thiol between 0.1:1.0 to 1.10:1.

Example 30. The composition of any one of Examples 1-29, wherein the PHU is derived using a starting ratio of carbonate to amine plus thiol between 0.65:1.0 to 1.05:1.

Example 31. The composition of any one of Examples 1-30, wherein the temperature range is between −20° C. and 120° C.

Example 32. The composition of any one of Examples 1-31, wherein the temperature range is between −15° C. and 80° C.

Example 33. The composition of any one of Examples 1-32, wherein the temperature range is between −10° C. and 60° C.

Example 34. The composition of any one of Examples 1-33, wherein the PCM melts, as positioned within the pores, at a first temperature, Tₘ, between −20° C. and 120° C.

Example 35. The composition of any one of Examples 1-34, wherein −10° C.≤Tₘ<60° C.

Example 36. The composition of any one of Examples 1-35, wherein 10° C.≤Tₘ<50° C.

Example 37. The composition of any one of Examples 1-36, wherein the PCM solidifies, as positioned within the pores, at a second temperature, T_{c}, between −40° C. and 120° C.

Example 38. The composition of any one of Examples 1-37, wherein −30° C.≤T_{c}<60° C.

Example 39. The composition of any one of Examples 1-38, wherein −20° C.≤T_{c}<20° C.

Example 40. The composition of any one of Examples 1-39, further comprising a surfactant.

Example 41. The composition of any one of Examples 1-40, wherein the surfactant comprises at least one of a polydimethyl siloxane or a material containing polyethylene oxide-co-polypropylene oxide.

Example 42. The composition of any one of Examples 1-41, wherein: the PHU foam is derived from reacting TMPTC, TMD, and EDT, the PCM comprises CaCl₂·6H₂O, and the solid additive comprises BaCO₃.

Example 43. The composition of any one of Examples 1-42, wherein the BaCO₃ is present at a concentration between 1 wt % and 10 wt %.

Example 44. The composition of any one of Examples 1-43, wherein the CaCl₂·6H₂O is present at a concentration between 1 wt % and 90 wt %.

Example 45. The composition of any one of Examples 1-44, wherein the concentration of the CaCl₂·6H₂O is between 10 wt % and 90 wt %.

Example 46. The composition of any one of Examples 1-45, wherein the concentration of the CaCl₂·6H₂O is between 10 wt % and 50 wt %.

Example 47. The composition of any one of Examples 1-46, wherein the composition is further characterized by an endotherm between 100 J/g and 300 J/g.

Example 48. The composition of any one of Examples 1-47, wherein the endotherm is between 135 J/g and 200 J/g.

Example 49. The composition of any one of Examples 1-48, wherein the endotherm is between 139 J/g and 186 J/g.

Example 50. The composition of any one of Examples 1-49, wherein the composition is capable of being cycled at least three times as characterized by repeated melting and freezing of the PCM (Panel A of FIG. 17B).

Example 51. The composition of any one of Examples 1-50, wherein the composition is further characterized by supercooling (Panel A of FIG. 17B).

Example 52. The composition of any one of Examples 1-51, wherein the supercooling corresponds to a crystallization temperature, T_{c}, occurring at least 5° C. below the same composition not containing the PCM (Panel A of FIG. 17B).

Example 53. The composition of any one of Examples 1-52, wherein the composition is further characterized by a time lag during the melting portion of a temperature versus time plot, relative to a temperature versus time plot of the composition not containing the PCM (FIG. 17D).

Example 54. The composition of any one of Examples 1-53, further comprising a gel point between 10° C. and 40° C.

Example 55. The composition of any one of Examples 1-54, further comprising a storage modulus (G′) between 0.66 MPa and 3.2 MPa.

Example 56. The composition of any one of Examples 1-55, further comprising a loss modulus (G″) between 0.03 MPa and 0.50 MPa.

Example 57. A method of making any composition of Examples 1-56, the method comprising: synthesizing the PHU foam, and infusing the PCM into the foam.

Example 58. The method of any one of Examples 1-57, wherein the infusing is performed by immersing the PHU foam in liquid PCM.

Example 59. The method of any one of Examples 1-58, wherein the infusing further includes exposing the PHU foam immersed in the liquid PCM to a vacuum.

Example 60. The method of any one of Examples 1-59, wherein the infusing is performed by injecting liquid PCM directly into the PHU foam.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, 5%, or ±1% of a specific numeric value or target. In some embodiments of the present invention, the term “about” is used to indicate an uncertainty limit of less than or equal to ±1%, 0.9%, 0.8%, ±0.7%, 0.6%, 0.5%, ±0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising:
a poly(hydroxy)urethane (PHU) foam;
a phase change material (PCM); and
a solid additive, wherein:
the PHU foam comprises a plurality of voids,
at least a portion of the voids contain the PCM and the solid additive, and
the composition is capable of being repeatedly cycled through a temperature range, resulting in the PCM cycling between a solid phase and a liquid phase.

2. The composition of claim 1, wherein the PCM comprises at least one of a hydrated salt, a paraffin wax, a sugar alcohol, a fatty acid, or a eutectic mixture.

3. The composition of claim 2, wherein the hydrated salt comprises at least one of calcium chloride hexahydrate (CaCl₂·6H₂O), Na₂SO₄·10H₂O, Na₂HPO₄·12H₂O, Na₂S₂O₃·5H₂O, CH₃COONa·3H₂O, KF·4H₂O, LiNO₃·3H₂O, or (Na₂[B₄O₅(OH)₄]·8H₂O).

4. The composition of claim 2, wherein the paraffin wax comprises a linear long chain hydrocarbon.

5. The composition of claim 1, wherein the PCM is present at a concentration 0 wt %<x≤85 wt %.

6. The composition of claim 1, wherein the PCM has a heat of fusion 50 J/g≤H≤250 J/g.

7. The composition of claim 1, wherein the solid additive comprises at least one of a carbonate salt, a metal oxide, a clay, a zeolite, or a carbonaceous material.

8. The composition of claim 7, wherein the carbonate salt comprises at least one of BaCO₃ or Ba₂SO₄.

9. The composition of claim 7, wherein the carbonaceous material comprises at least one of graphene, graphite, carbon nanotubes, or activated charcoal.

10. The composition of claim 9, wherein the carbonaceous material comprises graphite and the composition has a thermal conductivity between 0.18 W/mK and 0.195 W/mK.

11. The composition of claim 1, wherein the solid additive is present at a concentration 0 wt %<y≤10 wt %.

12. The composition of claim 1, wherein the PHU foam is derived from reacting a cyclic carbonate-containing molecule, an amine-containing molecule, and a thiol-containing molecule.

13. The composition of claim 12, wherein the cyclic carbonate-containing molecule comprises at least one of trimethylpropane tricarbonate (TMPTC), 4,4′-[1,4-cyclohexanediylbis (methyleneoxymethylene)]bis [1,3-dioxolan-2-one], 4,4′-[1,6-hexanediylbis (oxymethylene)]bis [1,3-dioxolan-2-one], 4,4′-[1,2-Ethanediylbis(oxymethylene)]bis [1,3-dioxolan-2-one], or ,4′-[1,4-butanediylbis(oxymethylene)] bis[1,3-dioxolan-2-one].

14. The composition of claim 12, wherein the amine-containing molecule comprises at least one of spermidine, putrescine (TMD), spermine, cadaverine, or m-xylene diamine.

15. The composition of claim 12, wherein the thiol-containing molecule comprises 2,2′-(ethylenedioxy)diethanethiol (EDT), decanethiol, or pentaerythritol tetrakis(3-mercaptopropionate).

16. The composition of claim 12, wherein the PHU foam is derived using a starting ratio of diamine to thiol between 10:1 and 1:1.

17. The composition of claim 12, wherein the PHU foam is derived using a starting ratio of carbonate to amine plus thiol between 0.1:1.0 to 1.10:1.

18. The composition of claim 1, wherein the temperature range is between −20° C. and 120° C.

19. The composition of claim 1, wherein the PCM melts, as positioned within the voids, at a first temperature, Tₘ, between −20° C. and 120° C.

21. The composition of claim 1, wherein the PCM solidifies, as positioned within the voids, at a second temperature, T_{c}, between −40° C. and 120° C.

21. The composition of claim 1, further comprising a surfactant.

22. The composition of claim 1, wherein:
the PHU foam is derived from reacting TMPTC, TMD, and EDT,
the PCM comprises CaCl₂·6H₂O, and
the solid additive comprises BaCO₃.

23. A method of making a PHU foam, the method comprising:
synthesizing the PHU foam by reacting an amine-containing molecule, a thiol-containing molecule, and a carbonate-containing molecule, and
infusing a PCM into the PHU foam.
